(19) United States
(12) Patent Application Publication
(10) Pub. No.: US 2026/0142723 A1
(43) Pub. Date: May 21, 2026

(54) TBPS DATA THROUGHPUT AT THZ FREQ USING CHIPLET ARCHITECTURE

(71) Applicant: Attotude, Inc., Menlo Park, CA (US)

(72) Inventors: Richard Chan, Menlo Park, CA (US); David F. Welch, Atherton, CA (US); Joy Laskar, Mountain View, CA (US); Sudipto Chakraborty, Plano, TX (US); Eric Juntunen, San Diego, CA (US); Rene Schmogrow, Menlo Park, CA (US); Kuang-Tsan Wu, Ottawa (CA)

(21) Appl. No.: 19/394,300

(22) Filed: Nov. 19, 2025

Related U.S. Application Data
(60) Provisional application No. 63/722,329, filed on Nov. 19, 2024.

(51) Int. Cl. H04B 10/40; H04L 25/49

(52) U.S. Cl. CPC H04B 10/40; H04L 25/4917; H04B 2210/517

(57) ABSTRACT

Transmitters, receivers, transceivers, transceiver arrays, and methods of use are described herein, including a transmitter comprising a carrier substrate comprising conductive pads, a client-side input comprising conductive traces disposed on the carrier substrate and operable to receive baseband signals and provide the baseband signals to the conductive pads, an interposer substrate abutting the carrier substrate and defining vias extending through the interposer substrate, a baseband transmitter circuit disposed on the interposer substrate and operable to receive the baseband signals from the conductive pads via the vias and generate intermediate signals, an up-conversion circuit operable to receive the intermediate signals from the baseband transmitter circuit and generate antenna feed signals having a frequency in a range between 300 Gigahertz (GHz) and 10 Terahertz (THz), and one or more antenna interfaces disposed on the interposer substrate and operable to receive the antenna feed signals and provide them to one or more antennas.

### REFERENCE TO RELATED APPLICATIONS

The present patent application claims priority to the United States provisional application identified by U.S. Ser. No. 63/772,329 filed on Nov. 19, 2024, the entire content of which is hereby incorporated herein by reference.

### BACKGROUND ART

Optical networking is a means of communication that uses signals encoded in light to transmit information in various types of telecommunications networks, including limited range local-area networks (LANs) or wide-area networks (WANs). It is a form of optical communication that relies on optical amplifiers, lasers, or LEDs and wavelength-division multiplexing (WDM) to transmit large quantities of data, generally across fiber-optic cables. Because it is capable of achieving extremely high bandwidth, it is an enabling technology for the Internet and telecommunication networks that transmit the vast majority of all human and machine-to-machine information. However, further development and optimization of optical networking systems face certain limiting factors, namely, power dissipation, thermal requirements, and mechanical tolerances.

Optical components generate photons by exciting electrons in a gain medium, and the electrons emit photons as they return to lower energy levels. Despite efforts to improve efficiency, optical components generate some amount of heat during the electron excitation process, and such heat is referred to as power dissipation. Excessive power dissipation may lead to thermal management problems and may affect the performance and longevity of the optical components.

Optical components are sensitive to temperature fluctuations and often require lower operating temperatures than purely electronic components to maintain optimal performance. Elevated temperatures may result in increased signal noise, diminished signal quality, and reduced service life for optical components. Accordingly, optical components often require cooling systems (e.g., heat sinks, fans, or thermoelectric devices) to dissipate excess heat and maintain the optical components within a safe temperature range.

Optical networking systems typically operate in micrometer wavelengths, demanding extreme precision in component fabrication, assembly, and alignment. Even slight deviations from the required mechanical tolerances may lead to signal degradation, loss, or the introduction of optical crosstalk, negatively impacting network performance. Achieving and maintaining the necessary mechanical tolerances necessitates advanced manufacturing techniques and stringent quality control measures.

Terahertz (THz) wireless communications in a frequency range between 300 Gigahertz (GHz) and 10 THz offer the potential for extremely high data rates, but face significant technical challenges. Existing approaches for transmitting and receiving dual-polarized THz signals have relied heavily on optical components, increasing complexity, cost, and power consumption.

Despite advancements in optical networking, existing systems struggle to achieve efficient operation in the THz frequency range. Existing techniques, such as anti-parallel diode-based mixing and varactor-based mixing, suffer from significant limitations. These methods produce inadequate output power levels, severely restricting their applicability in moderate-distance communication scenarios. While transistor models have shown promise in sub-THz frequencies, they fall short of meeting the demands of true THz wireless communication. Furthermore, the development of separate, accurate diode or varactor models for THz applications has proven to be a complex and resource-intensive process. Consequently, there exists a need for novel approaches that can overcome these limitations and enable efficient, long-range THz wireless communication without relying on the shortcomings of current mixing techniques or the complexities of developing new component models.

### SUMMARY

The problems existing in the field of optical networking are solved by the systems, assemblies, and methods disclosed herein.

In a first aspect, the present disclosure includes a transmitter, comprising: a carrier substrate having a carrier surface and comprising a plurality of first conductive pads disposed on the carrier surface; a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to the at least two first conductive pads; a baseband transmitter circuit disposed on the first interposer surface and operable to receive the one or more baseband signals from the at least two first conductive pads via the at least two vias and generate one or more intermediate signals based on the one or more baseband signals, each of the one or more intermediate signals having an intermediate frequency greater than the baseband frequency of a corresponding one of the one or more baseband signals; an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

In a second aspect, the present disclosure includes a receiver, comprising: a carrier substrate having a carrier surface and comprising a plurality of first conductive pads disposed on the carrier surface; an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to at least two first conductive pads of the plurality of first conductive pads; a baseband receiver circuit disposed on the first interposer surface; one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz); a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals; wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals; wherein the at least two first conductive pads are operable to receive the one or more baseband signals from the baseband receiver circuit via the at least two vias; and a client-side output comprising a plurality of conductive traces disposed on the carrier surface, at least two conductive traces of the plurality of conductive traces being operable to receive the one or more baseband signals from the at least two first conductive pads and transmit the one or more baseband signals.

In a third aspect, the present disclosure includes a transceiver, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to at least two first inbound conductive pads of the plurality of first inbound conductive pads; a baseband transmitter circuit disposed on the first interposer surface and operable to receive the one or more outbound baseband signals from the at least two first outbound conductive pads via the at least two first vias and generate one or more outbound intermediate signals based on the one or more outbound baseband signals, each of the one or more outbound intermediate signals having an outbound intermediate frequency greater than the outbound baseband frequency of a corresponding one of the one or more outbound baseband signals; a baseband receiver circuit disposed on the first interposer surface; an up-conversion circuit having an up-conversion surface and comprising a plurality of second outbound conductive pads disposed on the up-conversion surface, the up-conversion surface abutting the first interposer surface such that at least two second outbound conductive pads of the plurality of second outbound conductive pads are electrically coupled to the baseband transmitter circuit, the up-conversion circuit being operable to receive the one or more outbound intermediate signals from the baseband transmitter circuit via the at least two second outbound conductive pads and generate one or more antenna feed signals based on the one or more outbound intermediate signals, each of the one or more antenna feed signals having an outbound transmission frequency greater than the outbound intermediate frequency of a corresponding one of the one or more outbound intermediate signals and in a range between 300 Gigahertz (GHz) and 10 Terahertz (THz); one or more outbound antenna interfaces disposed on the first interposer surface, each of the one or more outbound antenna interfaces being configured to be electrically coupled to one or more outbound antennas and operable to receive the one or more antenna feed signals from the up-conversion circuit and provide the one or more antenna feed signals to the one or more outbound antennas; one or more inbound antenna interfaces disposed on the first interposer surface, each of the one or more inbound antenna interfaces being configured to be electrically coupled to one or more inbound antennas and operable to receive one or more antenna output signals from the one or more inbound antennas, each of the one or more antenna output signals having inbound client data encoded therein and an inbound transmission frequency in a range between 300 GHz and 10 THz; a down-conversion circuit having a down-conversion surface and comprising a plurality of second inbound conductive pads disposed on the down-conversion surface, the down-conversion surface abutting the first interposer surface such that at least two second inbound conductive pads of the plurality of second inbound conductive pads are electrically coupled to the baseband receiver circuit, the down-conversion circuit being operable to receive the one or more antenna output signals from the one or more inbound antenna interfaces and generate one or more inbound intermediate signals based on the one or more antenna output signals, each of the one or more inbound intermediate signals having an inbound intermediate frequency less than the inbound transmission frequency of a corresponding one of the one or more antenna output signals; wherein the baseband receiver circuit is operable to receive the one or more inbound intermediate signals from the down-conversion circuit via the at least two second inbound conductive pads and generate one or more inbound baseband signals based on the one or more inbound intermediate signals, each of the one or more inbound baseband signals having an inbound baseband frequency less than the inbound intermediate frequency of a corresponding one of the one or more inbound intermediate signals; wherein the at least two first inbound conductive pads of the plurality of first inbound conductive pads are operable to receive the one or more inbound baseband signals from the baseband receiver circuit via the at least two second vias; and a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

In a fourth aspect, the present disclosure includes a transceiver, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of are aligned with and electrically coupled to at least two first inbound conductive pads of the plurality of first inbound conductive pads; a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals; a baseband receiver circuit disposed on the first interposer surface; a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz); one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas; a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz; one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas; one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz; a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals; one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz; a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals; wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals; wherein the at least two first inbound conductive pads are operable to receive the one or more inbound baseband signals from the baseband receiver circuit via the at least two second vias; and a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

In a fifth aspect, the present disclosure includes a transceiver array, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; a client-side output comprising a plurality of second conductive traces disposed on the carrier surface, at least two second conductive traces of the plurality of second conductive traces being operable to receive one or more inbound baseband signals from at least two first inbound conductive pads of the plurality of first inbound conductive pads and transmit the one or more inbound baseband signals; and a plurality of transceivers, each of the plurality of transceivers comprising: an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to the at least two first inbound conductive pads; a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals; a baseband receiver circuit disposed on the first interposer surface; a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz); one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas; a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz; one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas; one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz; a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals; one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz; a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals; wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate the one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals; and wherein the at least two first inbound conductive pads are operable to receive the one or more inbound baseband signals from the baseband receiver circuit via the at least two second vias.

In a sixth aspect, the present disclosure includes a transmitter, comprising: a carrier substrate having a carrier surface and comprising a plurality of first conductive pads disposed on the carrier surface; a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency; an interposer substrate having a first interposer surface and a second interposer surface opposite the first interposer surface, the second interposer surface abutting the carrier surface; a baseband transmitter circuit disposed on the first interposer surface and operable to receive the one or more baseband signals from the at least two first conductive pads via two or more wire bond connections extending between the at least two first conductive pads and the baseband transmitter circuit and generate one or more intermediate signals based on the one or more baseband signals, each of the one or more intermediate signals having an intermediate frequency greater than the baseband frequency of a corresponding one of the one or more baseband signals; an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

In a seventh aspect, the present disclosure includes a receiver, comprising: a carrier substrate having a carrier surface and comprising a plurality of first conductive pads disposed on the carrier surface; an interposer substrate having a first interposer surface and a second interposer surface opposite the first interposer surface, the second interposer surface abutting the carrier surface; a baseband receiver circuit disposed on the first interposer surface; one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz); a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals; wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals; wherein the at least two first conductive pads are operable to receive the one or more baseband signals from the baseband receiver circuit via two or more wire bond connections extending between the baseband receiver circuit and the at least two first conductive pads; and a client-side output comprising a plurality of conductive traces disposed on the carrier surface, at least two conductive traces of the plurality of conductive traces being operable to receive the one or more baseband signals from the at least two first conductive pads and transmit the one or more baseband signals.

The foregoing summary provides an overview of certain selected embodiments or embodiments disclosed herein, and is not intended to describe every aspect, embodiment, embodiment, feature, or advantage of the disclosure exhaustively or comprehensively. Therefore, this Summary should not be construed in such a way to limit the scope of this disclosure or to limit the scope of the claims. The details of one or more embodiment or embodiment disclosed herein are set forth in the accompanying drawings and descriptions below. Other aspects, features, embodiments, embodiments, and advantages will become readily apparent in view of the description, the drawings, and the claims set forth herein.

### BRIEF DESCRIPTION OF THE DRAWINGS

The accompanying drawings, which are incorporated in and constitute a part of this specification, illustrate one or more embodiment described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an electromagnetic (EM) spectrum;

FIG. 2 is a block diagram of an exemplary embodiment of a transport network constructed in accordance with the present disclosure;

FIG. 3A is a cross-sectional view of an exemplary embodiment of a first hollow waveguide shown in FIG. 2, taken along the line 3-3′ and in the direction of the arrows;

FIG. 3B is a cross-sectional view of another exemplary embodiment of the first hollow waveguide shown in FIG. 2, taken along the line 3-3′ and in the direction of the arrows, wherein the first hollow waveguide lacks an optional dielectric layer;

FIG. 3C is a cross-sectional view of another exemplary embodiment of the first hollow waveguide shown in FIG. 2, taken along the line 3-3′ and in the direction of the arrows, wherein the first hollow waveguide lacks an optional support layer;

FIG. 3D is a cross-sectional view of another exemplary embodiment of the first hollow waveguide shown in FIG. 2, taken along the line 3-3′ and in the direction of the arrows, wherein the first hollow waveguide lacks the optional dielectric layer and the optional support layer;

FIG. 3E is a cross-sectional view of another exemplary embodiment of the first hollow waveguide shown in FIG. 2, taken along the line 3-3′ and in the direction of the arrows, wherein the first hollow waveguide is a photonic-bandgap fiber;

FIG. 3F is a cross-sectional view of another exemplary embodiment of the first hollow waveguide shown in FIG. 2, taken along the line 3-3′ and in the direction of the arrows, wherein the first hollow waveguide has a hollow waveguide core with an elliptical cross-section;

FIG. 3G is a cross-sectional view of another exemplary embodiment of the first hollow waveguide shown in FIG. 2, taken along the line 3-3′ and in the direction of the arrows, wherein the hollow waveguide core of the first hollow waveguide has a rectangular cross-section;

FIG. 3H is a cross-sectional view of another exemplary embodiment of the first hollow waveguide shown in FIG. 2, taken along the line 3-3′ and in the direction of the arrows, wherein the hollow waveguide core of the first hollow waveguide has a square cross-section;

FIG. 3I is a cross-sectional view of another exemplary embodiment of the first hollow waveguide shown in FIG. 2, taken along the line 3-3′ and in the direction of the arrows, wherein the hollow waveguide core of the first hollow waveguide has a cross-shaped cross-section;

FIG. 3J is a cross-sectional view of another exemplary embodiment of the first hollow waveguide shown in FIG. 2, taken along the line 3-3′ and in the direction of the arrows, wherein the first hollow waveguide is a solid rod fiber;

FIG. 3K is a cross-sectional view of another exemplary embodiment of the first hollow waveguide shown in FIG. 2, taken along the line 3-3′ and in the direction of the arrows, wherein the first hollow waveguide is a microstructured optical fiber;

FIG. 3L is a cross-sectional view of another exemplary embodiment of the first hollow waveguide shown in FIG. 2, taken along the line 3-3′ and in the direction of the arrows, wherein the first hollow waveguide is a porous fiber;

FIG. 3M is a cross-sectional view of another exemplary embodiment of the first hollow waveguide shown in FIG. 2, taken along the line 3-3′ and in the direction of the arrows, wherein the first hollow waveguide is a suspended porous-core fiber;

FIG. 3N is a cross-sectional view of another exemplary embodiment of the first hollow waveguide shown in FIG. 2, taken along the line 3-3′ and in the direction of the arrows, wherein the first hollow waveguide is a suspended slotted core fiber;

FIG. 3O is a cross-sectional view of another exemplary embodiment of the first hollow waveguide shown in FIG. 2, taken along the line 3-3′ and in the direction of the arrows, wherein the first hollow waveguide is a hollow-core bandgap fiber;

FIG. 3P is a cross-sectional view of another exemplary embodiment of the first hollow waveguide shown in FIG. 2, taken along the line 3-3′ and in the direction of the arrows, wherein the first hollow waveguide is a hollow-core tube fiber;

FIG. 3Q is a cross-sectional view of another exemplary embodiment of the first hollow waveguide shown in FIG. 2, taken along the line 3-3′ and in the direction of the arrows, wherein the first hollow waveguide is a hollow-core fiber with negative curvature;

FIG. 3R is a cross-sectional view of another exemplary embodiment of the first hollow waveguide shown in FIG. 2, taken along the line 3-3′ and in the direction of the arrows, wherein the first hollow waveguide is a hollow-core fiber based on anti-resonances and inhibited coupling;

FIG. 3S is a cross-sectional view of another exemplary embodiment of the first hollow waveguide shown in FIG. 2, taken along the line 3-3′ and in the direction of the arrows, wherein the first hollow waveguide is a hollow-core nested anti-resonant nodeless fiber;

FIG. 3T is a cross-sectional view of another exemplary embodiment of the first hollow waveguide shown in FIG. 2, taken along the line 3-3′ and in the direction of the arrows, wherein the first hollow waveguide is a 3D-printed hollow-core fiber based on anti-resonances and inhibited coupling;

FIG. 3U is a cross-sectional view of another exemplary embodiment of the first hollow waveguide shown in FIG. 2, taken along the line 3-3′ and in the direction of the arrows, wherein the first hollow waveguide is a Bragg fiber;

FIG. 4A is a block diagram of an exemplary embodiment of a first transmitter shown in FIG. 2;

FIG. 4B is a block diagram of another exemplary embodiment of the first transmitter shown in FIG. 2, wherein the first transmitter comprises a serializer;

FIG. 4C is a block diagram of another exemplary embodiment of the first transmitter shown in FIG. 2, wherein the first transmitter comprises a deserializer;

FIG. 4D is a block diagram of an exemplary embodiment of transmitter circuitry shown in FIG. 4A;

FIG. 4E is a block diagram of another exemplary embodiment of the transmitter circuitry shown in FIG. 4A, wherein the transmitter circuitry comprises a combiner;

FIG. 4F is a block diagram of another exemplary embodiment of the first transmitter shown in FIG. 2;

FIG. 4G is a block diagram of another exemplary embodiment of the first transmitter shown in FIG. 2;

FIG. 5A is a block diagram of an exemplary embodiment of a first receiver shown in FIG. 2;

FIG. 5B is a block diagram of another exemplary embodiment of the first receiver shown in FIG. 2, wherein the first receiver comprises a deserializer;

FIG. 5C is a block diagram of another exemplary embodiment of the first receiver shown in FIG. 2, wherein the first receiver comprises a serializer;

FIG. 5D is a block diagram of an exemplary embodiment of receiver circuitry shown in FIG. 5A;

FIG. 5E is a block diagram of another exemplary embodiment of the receiver circuitry shown in FIG. 5A, wherein the receiver circuitry comprises a splitter;

FIG. 5F is a block diagram of another exemplary embodiment of the first receiver shown in FIG. 2;

FIG. 5G is a block diagram of another exemplary embodiment of the first receiver shown in FIG. 2;

FIG. 6A is a block diagram of an exemplary embodiment of a transceiver shown in FIG. 2;

FIG. 6B is a block diagram of another exemplary embodiment of the transceiver shown in FIG. 2;

FIG. 7 is a schematic diagram of a folded modulator constructed in accordance with the present disclosure;

FIG. 8 is a schematic diagram of a rectifying detector constructed in accordance with the present disclosure;

FIG. 9A is a side view of an exemplary embodiment of an antenna constructed in accordance with the present disclosure for generating circularly polarized signals;

FIG. 9B is a side view of another exemplary embodiment of the antenna shown in FIG. 9A;

FIG. 10 is an isometric partial cross-sectional view of another exemplary embodiment of a transceiver constructed in accordance with the present disclosure, wherein the transceiver is disposed on an interposer substrate;

FIG. 11 is an isometric partial cross-sectional view of another exemplary embodiment of the transceiver shown in FIG. 10, wherein the interposer substrate is disposed on a carrier substrate and an up-conversion circuit and a down-conversion circuit are integrated into a single semiconductor die;

FIG. 12 is an isometric partial cross-sectional view of another exemplary embodiment of the transceiver shown in FIG. 10, wherein the transceiver comprises a plurality of outbound antenna interfaces and a plurality of inbound antenna interfaces and the up-conversion circuit and the down-conversion circuit are integrated into a single semiconductor die;

FIG. 13 is an isometric partial cross-sectional view of exemplary embodiments of a first semiconductor die and a second semiconductor die constructed in accordance with the present disclosure, wherein the first semiconductor die and the second semiconductor die are disposed on the interposer substrate;

FIG. 14 is an isometric partial cross-sectional view of another exemplary embodiment of the transceiver shown in FIG. 10, wherein the interposer substrate is disposed on the carrier substrate and a baseband transmitter circuit and a baseband receiver circuit are integrated into a single semiconductor die;

FIG. 15 is an isometric partial cross-sectional view of another exemplary embodiment of the transceiver shown in FIG. 10, wherein the interposer substrate is disposed on the carrier substrate, the baseband transmitter circuit and the baseband receiver circuit are integrated into a first semiconductor die, and the up-conversion circuit and the down-conversion circuit are integrated into a second semiconductor die;

FIG. 16 is a top plan view of an exemplary embodiment of a transceiver array constructed in accordance with the present disclosure; and

FIG. 17 is an isometric partial cross-sectional view of another exemplary embodiment of the transceiver shown in FIG. 10, wherein the interposer substrate is disposed on the carrier substrate, the baseband transmitter circuit and the baseband receiver circuit are integrated into a single semiconductor die, and the interposer substrate is electrically coupled to a client-side input via wire bond baseband connections.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As used herein, “circuitry” may refer to analog and/or digital components, or one or more suitably programmed processor (e.g., a microprocessor) and associated hardware and software, or hardwired logic. Also, “circuitry” may perform one or more function. The term “circuitry” may include hardware, such as a processor (e.g., microprocessor), a combination of hardware and software, and/or the like. Software may include one or more processor-executable instruction that when executed by one or more processor cause the one or more processor to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

As used herein, a “mode” refers to a unique distribution of electric and magnetic fields which repeat along the length of a hollow waveguide by which electromagnetic energy may be transported through the hollow waveguide. “Single-mode” refers to a hollow waveguide designed to carry only one mode of electromagnetic wave. This is achieved by having a narrow core diameter, which allows only one mode of light to propagate at a time. On the other hand, “multi-mode” refers to a hollow waveguide designed to carry multiple modes of electromagnetic waves simultaneously. This is possible due to its larger core diameter, which enables multiple modes to be propagated.

As used herein, “Amplitude Modulation” (AM) refers to a form of signal modulation in which data is encoded in an amplitude of a carrier signal.

As used herein, “Amplitude-Shift Keying” (ASK) refers to a form of AM in which digital data is encoded in an amplitude of a carrier signal, and each symbol (i.e., representing one or more data bit) is sent by transmitting a fixed-amplitude carrier wave at a fixed frequency for a specific time period.

As used herein, “Phase-Shift Keying” (PSK) is a form of signal modulation in which signal data is encoded in a phase of a carrier signal having a constant frequency. “Quadrature PSK” (PSK) Is a form of PSK in which two data bits (i.e., 00, 01, 10, or 11) are modulated at once, selecting one of four possible carrier phase shifts (i.e., 0°, 90°, 180°, or 270°).

As used herein, “Pulse-Amplitude Modulation” (PAM) refers to a form of AM in which a data signal is encoded in an amplitude of a series of carrier signal pulses. “PAM4” refers to a form of PAM in which a data signal is encoded in an amplitude of a series of carrier signal pulses, in which the amplitude of the carrier signal pulses may be one of four discrete values (i.e., 0, 1, 2, or 3) and each carrier signal pulse represents two data bits (i.e., 00, 01, 10, or 11).

As used herein, “Non-Return-to-Zero” (NRZ) refers to a form of signal modulation in which a binary data signal is encoded in a carrier signal such that ones are represented by a first significant condition (e.g., a positive voltage) and zeroes are represented by a second significant condition (e.g., a negative voltage). “Non-return-to-Zero, Inverted” (NRZI) refers to a form of signal modulation in which the data bits are represented by the presence or absence of a transition at a clock boundary.

As used herein, “Quadrature Amplitude Modulation” (QAM) refers to a form of AM in which two analog message signals or two digital bit streams are encoded in amplitudes of two carrier waves, using either ASK or AM, and the two carrier signals are out of phase with each other by 90°. “QAM16” refers to a form of QAM in which the carrier signals may exist in one of sixteen discrete states (i.e., symbols) having one of sixteen different amplitude and phase levels representing four data bits (i.e., from 0000 to 1111).

As used herein, “Trellis Coded Modulation” (TCM) refers to a form of signal modulation in which a binary data signal is encoded in a phase of a constant amplitude carrier signal. The transmitted signal is created by convolutionally encoding the binary data signal and mapping the result to a signal constellation.

As used herein, “Rayleigh range” refers to the distance along the propagation direction of a beam from the waist to the place where the area of the cross section is doubled.

As used herein, “hollow waveguide” refers to a structure that guides waves by restricting transmission of energy in a particular direction. In the context of the present disclosure, “hollow waveguide” may refer to an optical fiber having a waveguide core operable to propagate RF signals in the THz frequency band or a routed waveguide operable to propagate RF signals in the THz frequency band.

As used herein, “diameter” refers to a straight line passing from side to side through the center of a body or figure. In some embodiments, the body or figure has a circular shape having a uniform diameter or an elliptical shape having multiple different diameters.

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

As used herein, “lane” refers to an independent physical signal path or channel capable of transmitting serialized data. A single lane may be capable of transmitting differential signals (i.e., pairs of complementary signals which propagate on two conductors) or single-ended signals (i.e., signals which propagate on one conductor referenced against a common ground, with another conductor electrically coupled to the common ground).

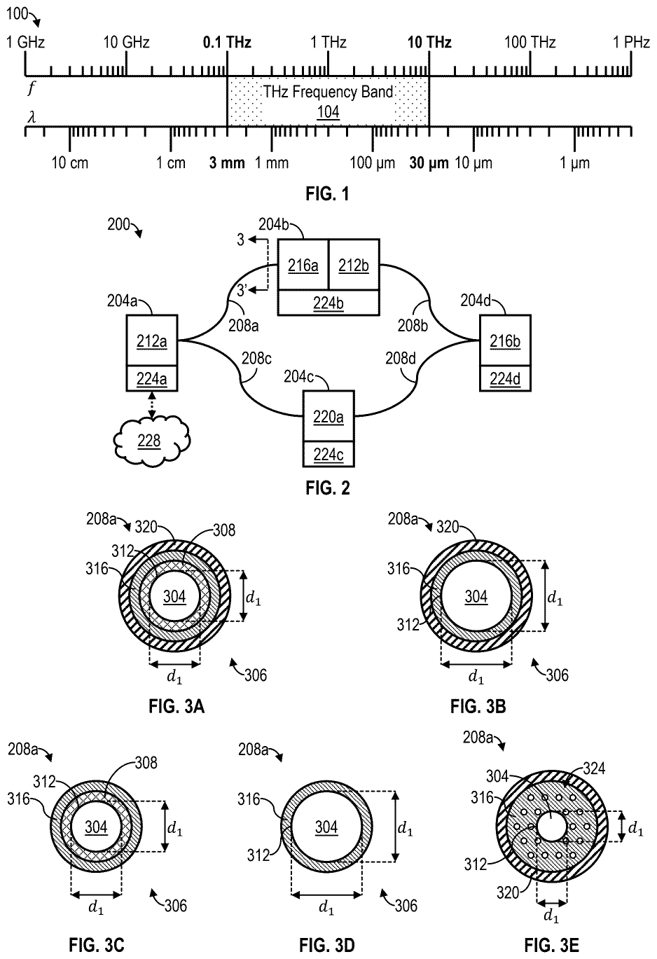

Referring now to the drawings, and in particular to FIG. 1, shown therein is a diagrammatic view of an electromagnetic (EM) spectrum 100 in accordance with the present disclosure. The present disclosure is generally related to network elements that communicate using radiated signals comprising radiated electromagnetic waves coupled into hollow waveguides. The radiated signals described herein generally have a transmission frequency in what is referred to as a Terahertz (THz) frequency band 104 (i.e., frequencies between 0.1 THz and 10 THz corresponding to wavelengths between 3 millimeters (mm) and 30 micrometers (μm)). However, in some embodiments described herein, the transmission frequency of the radiated signals is in a range between 300 Gigahertz (GHz) and 10 THz. The radiated signals described herein are generally configured for coherent detection and generally have a bandwidth in a range between 10% and 40% of the transmission frequency.

Referring now to FIG. 2, shown therein is a block diagram of an exemplary embodiment of a transport network 200 (hereinafter, the “transport network 200”) constructed in accordance with the present disclosure. The transport network 200 is depicted as comprising a plurality of network elements 204a-n (hereinafter, the “network elements 204”) (e.g., a first network element 204a, a second network element 204b, a third network element 204c, and a fourth network element 204d shown in FIG. 2). While only four of the network elements 204 are shown in FIG. 2 for exemplary purposes, it should be understood that the transport network 200 may comprise a number of the network elements 204 that may be greater or fewer than four.

The transport network 200 may further comprise one or more hollow waveguides 208a-n (hereinafter, the “hollow waveguides 208”) (e.g., a first hollow waveguide 208a, a second hollow waveguide 208b, a third hollow waveguide 208c, and a fourth hollow waveguide 208d shown in FIG. 2). While only four of the hollow waveguides 208 are shown in FIG. 2 for exemplary purposes, it should be understood that the transport network 200 may comprise a number of the hollow waveguides 208 that may be greater or fewer than four.

Radiated signals transmitted within the transport network 200 from the first network element 204a to the fourth network element 204d or vice versa may travel along (1) a first path formed by the first hollow waveguide 208a, the second network element 204b, and the second hollow waveguide 208b or (2) a second path formed by the third hollow waveguide 208c, the third network element 204c, and the fourth hollow waveguide 208d.

In some embodiments, each of the hollow waveguides 208 is configured to support propagation of radiated signals in only a single direction. However, in other embodiments, one or more of the hollow waveguides 208 may be configured to support propagation of radiated signals in a plurality of directions (i.e., two opposing directions). In embodiments where one or more of the hollow waveguides 208 are configured to support propagation of radiated signals in a plurality of directions, a first radiated signal being propagated through the hollow waveguide 208 in a first direction may be differentiated from a second radiated signal being propagated through the hollow waveguide 208 in a second direction opposite the first direction by being provided with a different polarization, frequency, etc. In some such embodiments, one or more circulator may be included to achieve such differentiation.

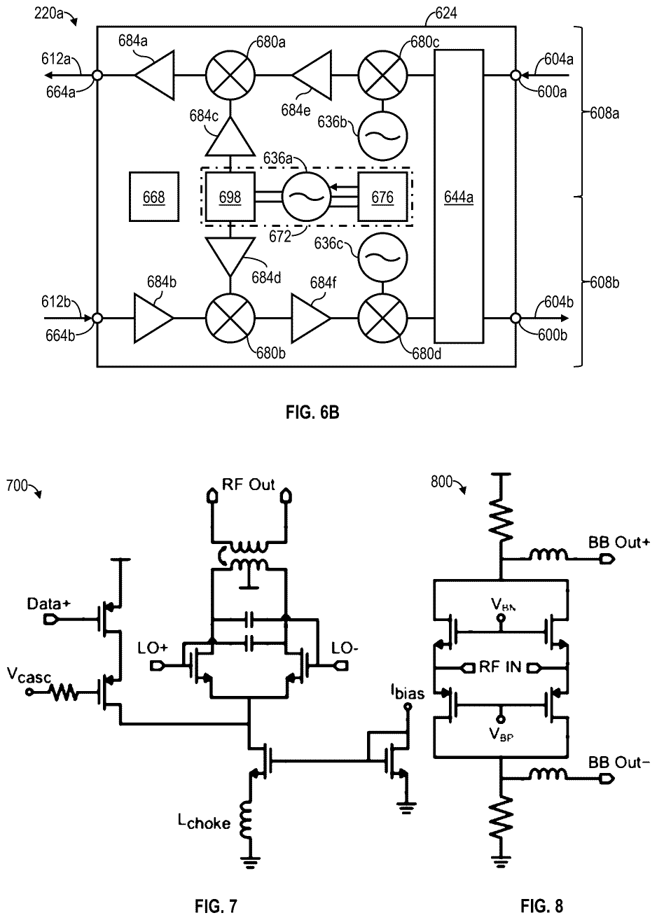

Each of the network elements 204 may comprise one or more of a transmitter 212 (e.g., a first transmitter 212a and a second transmitter 212b shown in FIG. 2) operable to transmit radiated signals comprising radiated electromagnetic waves having client data encoded therein via the hollow waveguides 208, a receiver 216 (e.g., a first receiver 216a and a second receiver 216b shown in FIG. 2) operable to receive radiated signals comprising radiated electromagnetic waves having client data encoded therein via the hollow waveguides 208, and/or a transceiver 220 (e.g., a first transceiver 220a shown in FIG. 2 and a second transceiver 220b shown in FIG. 6B) operable to transmit first radiated signals comprising first radiated electromagnetic waves having first client data encoded therein via particular ones of the hollow waveguides 208 and/or receive second radiated signals comprising second radiated electromagnetic waves having second client data encoded therein via other ones of the hollow waveguides 208.

Each of the network elements 204 may further comprise a control module 224 (e.g., a first control module 224a, a second control module 224b, a third control module 224c, and a fourth control module 224d shown in FIG. 2) (collectively, the “control modules 224”) operable to regulate one or more operating parameter of the network element 204 to which the control module 224 is coupled.

In some embodiments, one or more of the network elements 204 may communicate with each other via a communication network 228. The communication network 228 may permit bidirectional communication of information and/or data between one or more of the network elements 204 of the transport network 200. The communication network 228 may interface with one or more of the network elements 204 in a variety of ways. For example, in some embodiments, the communication network 228 may interface by optical and/or electronic interfaces, and/or may use a plurality of network topographies and/or protocols including, but not limited to, Ethernet, TCP/IP, circuit switched path, combinations thereof, and/or the like. The communication network 228 may utilize a variety of network protocols to permit bidirectional interface and/or communication of data and/or information between one or more of the network elements 204.

The communication network 228 may be almost any type of network. For example, in some embodiments, the communication network 228 may be a version of an Internet network (e.g., exist in a TCP/IP-based network). In one embodiment, the communication network 228 is the Internet. It should be noted, however, that the communication network 228 may be almost any type of network and may be implemented as the World Wide Web (i.e., the Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 228 is the Internet, a primary user interface of the transport network 200 may be delivered through a series of web pages or private internal web pages of a company or corporation, which may be written in hypertext markup language, JavaScript, or the like, and accessible by the user. It should be noted that the primary user interface of the transport network 200 may be another type of interface including, but not limited to, a Windows-based application, a tablet-based application, a mobile web interface, a VR-based application, an application running on a mobile device, and/or the like. In one embodiment, the communication network 228 may be connected to one or more of the network elements 204.

The number of devices and/or networks illustrated in FIG. 2 is provided for exemplary purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200.

The network elements 204 may take many different forms. For example, the network elements 204 may be integrated circuits (ICs). In this example, the network elements 204 (e.g., ICs) may communicate via signals comprising radiated electromagnetic waves having client data encoded therein via the hollow waveguides 208 without requiring electrical data busses. In other embodiments, the network elements 204 may be incorporated into components in a data center, such as servers, routers, switches, firewalls, storage systems, application delivery controllers, and/or the like to establish communication between such components in the data center via signals comprising radiated electromagnetic waves having client data encoded therein propagated through the hollow waveguides 208. The hollow waveguides 208 may thus extend from one integrated circuit to another integrated circuit, or from one component to another component, and such may be implemented in a variety of ways, such as IC-to-IC communications, printed circuit board (PCB)-to-PCB communications, component-to-component communications, and/or combinations thereof. In the example of PCB-to-PCB communications, the network elements 204 may each include a PCB.

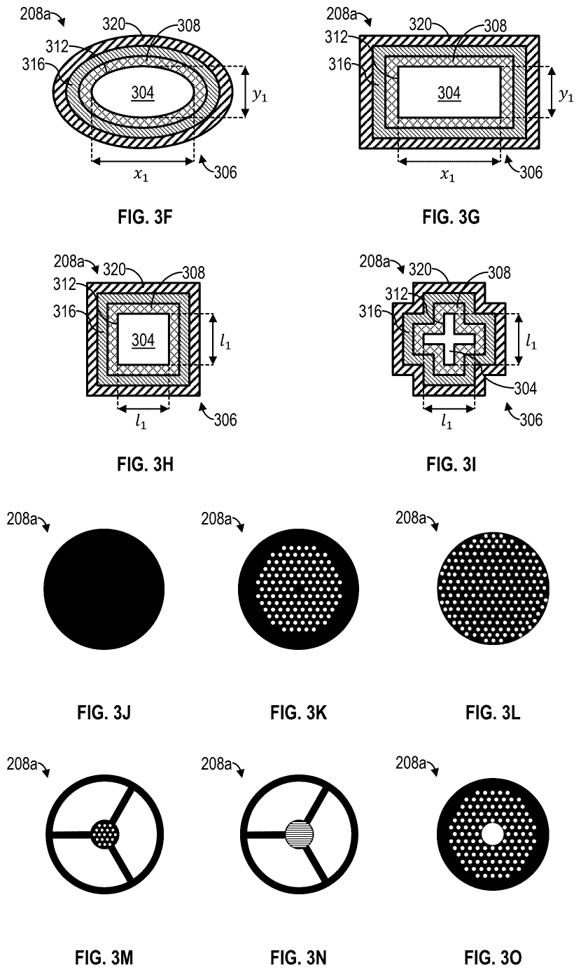

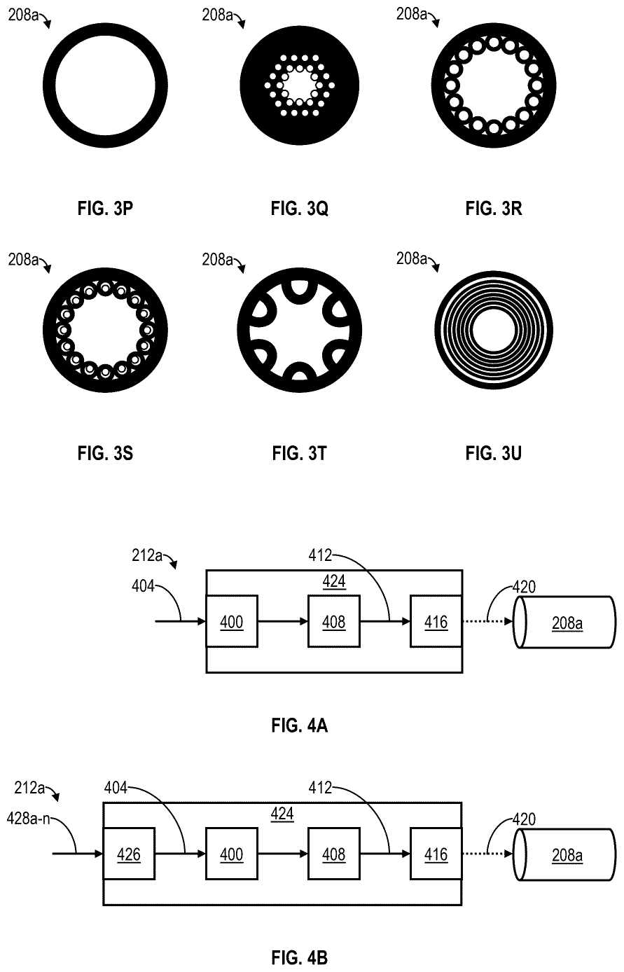

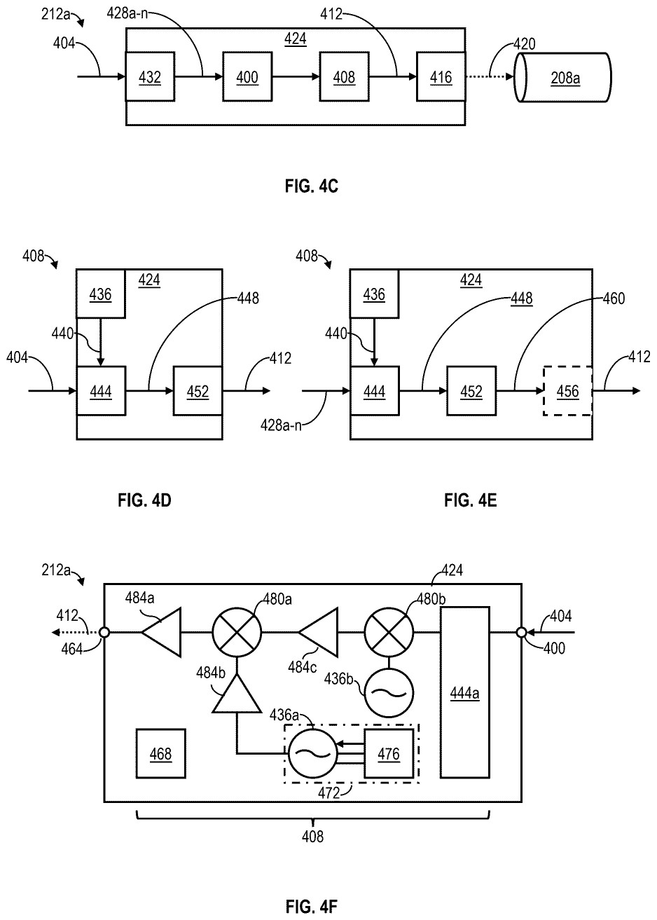

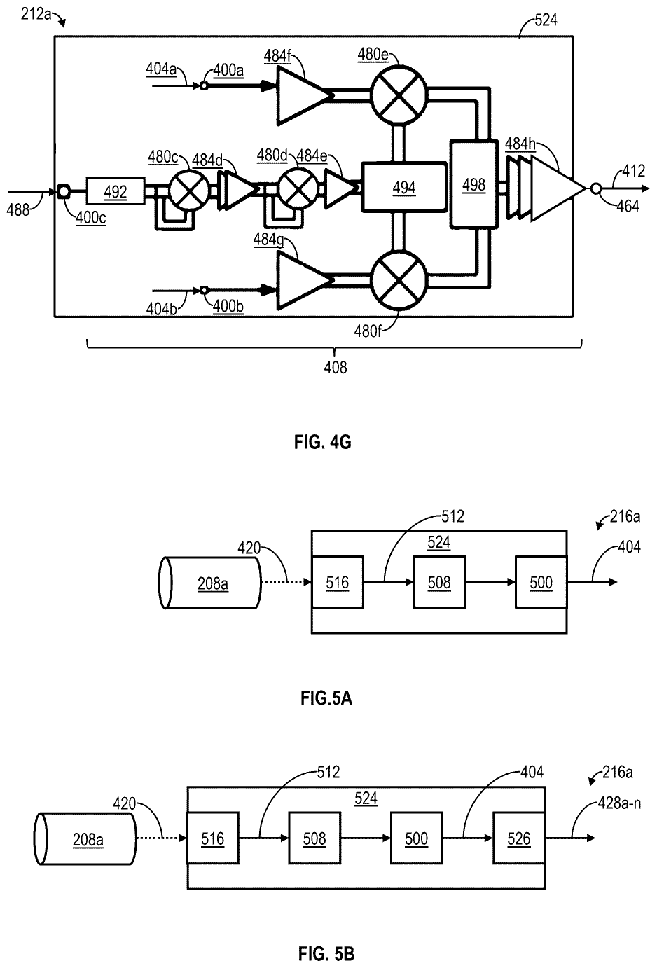

Referring now to FIGS. 3A-3H and 4A-4L, shown therein are cross-sectional views of various exemplary embodiments of the first hollow waveguide 208a shown in FIG. 2, taken along the line 3-3′ and in the direction of the arrows. However, it should be understood that the description referring to FIGS. 3A-3H and 4A-4L may be applicable to any of the hollow waveguides 208 described herein. In the embodiments shown in FIGS. 3A-3H and 4A-4L, the first hollow waveguide 208a is a hollow fiber. However, it should be understood that in other embodiments, the first hollow waveguide 208a may be another form of hollow waveguide, such as a substrate-integrated waveguide, for example.

The first hollow waveguide 208a (and, therefore, each of the hollow waveguides 208) generally comprises a hollow waveguide core 304 and a tubular sidewall 306 having an inner surface 312 in some embodiments defining the hollow waveguide core 304 or in other embodiments simply surrounding the hollow waveguide core 304.

Generally, the hollow waveguide core 304 may be composed of any material capable of propagating radiated electromagnetic waves within the THz frequency band 104 or, in some embodiments, in the range between 300 GHz and 10 THz. More particularly, the hollow waveguide core 304 may be composed of any materials having a low absorption loss (i.e., an absorption loss in a range between 1 dB/km and 10,000 dB/km) within the THz frequency band 104, or in some embodiments, in the range between 300 GHz and 10 THz.

In some embodiments, the hollow waveguide core 304 may be composed of a polymer (e.g., cyclic olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass).

In other embodiments, the hollow waveguide core 304 may be composed of a gas, a vacuum, or a porous material (i.e., a material having a porosity in a range between 25% and 99%). In such embodiments, the hollow waveguide core 304 may have a refractive index in a range between 1.0 and 1.4, for example. As discussed in more detail below, the hollow waveguide core 304 may have a refractive index n₁.

In some embodiments, the hollow waveguide core 304 may have a cross-section configured to support propagation of radiated signals having only a single polarization at a given time. However, in other embodiments, the hollow waveguide core 304 may have a cross-section configured to support propagation of radiated signals having a plurality of polarizations at a given time. In either case, the hollow waveguide core 304 may have a cross-section configured to support propagation of radiated signals having one or more linear polarizations or one or more circular polarizations.

In some embodiments, the hollow waveguide core 304 may have a cross-section configured to support propagation of radiated signals having only a single mode at a given time. However, in other embodiments, the hollow waveguide core 304 may have a cross-section configured to support propagation of radiated signals having a plurality of modes at a given time.

The tubular sidewall 306 of the first hollow waveguide 208a (and, therefore, each of the hollow waveguides 208) may comprise a conductive layer 316 (shown in FIGS. 3A-3I) surrounding the hollow waveguide core 304, a dielectric layer 308 (shown in FIGS. 3A, 3C, and 3F-3I) optionally disposed between the hollow waveguide core 304 and the conductive layer 316, and a support layer 320 (shown in FIGS. 3A, 3B, and 3E-3I) optionally surrounding the conductive layer 316.

In some embodiments, the tubular sidewall 306 of the first hollow waveguide 208a (and, therefore, each of the hollow waveguides 208) may comprise a plurality of the conductive layer 316 interleaved with a plurality of the dielectric layer 308.

In some embodiments, the tubular sidewall 306 of the first hollow waveguide 208a (and, therefore, each of the hollow waveguides 208) may further comprise one or more strength members (not shown) (hereinafter, the “strength members”) surrounding the conductive layer 316 configured to enhance resilience of the first hollow waveguide 208a. In such embodiments, the support layer 320 may surround the strength members.

Generally, the conductive layer 316 may be composed of any material having a refractive index n₃ greater than the refractive index of the hollow waveguide core 304 (i.e., n₁). More particularly, the conductive layer 316 may be composed of a non-oxidizing metallic material (e.g., silver, gold, or indium tin oxide (ITO)). Providing the conductive layer 316 with a refractive index greater than the refractive index of the hollow waveguide core 304 may cause an effective index Δn of the first hollow waveguide 208a to increase, thereby causing more radiated signals to be confined and propagated within the hollow waveguide core 304.

Generally, in embodiments in which the dielectric layer 308 is disposed between the conductive layer 316 and the hollow waveguide core 304, the dielectric layer 308 may be composed of any material having a refractive index n₂ greater than the refractive index of the hollow waveguide core 304 (i.e., n₁). More particularly, the dielectric layer 308 may be composed of a polymer (e.g., cyclic olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass), but particularly a material having a refractive index n₂ greater than the refractive index of the hollow waveguide core 304 (i.e., n₁) in that embodiment. Providing the dielectric layer 308 with a refractive index greater than the refractive index of the hollow waveguide core 304 may cause an effective index Δn of the first hollow waveguide 208a to increase, thereby causing more radiated signals to be confined and propagated within the hollow waveguide core 304.

The support layer 320 may be configured to shield the inner layers of the first hollow waveguide 208a (and, therefore, any of the hollow waveguides 208) from external environmental factors, provide flexibility to the first hollow waveguide 208a, and/or enhance a tensile strength of the first hollow waveguide 208a. In some embodiments, the support layer 320 may be composed of polymer materials, such as acrylate polymer or polyimide, for example.

In some embodiments, the cross-section of the hollow waveguide core 304 may have a circular shape (i.e., having a diameter d₁ that is equal along both the x-axis and the y-axis) (shown in FIGS. 3A-3D). In some such embodiments, the diameter d₁ of the hollow waveguide core 304 may be between 30 μm and 6 mm. In some such embodiments, the diameter d₁ of the hollow waveguide core 304 may be between 30 μm and 3 mm. In at least one such embodiment, the diameter d₁ of the hollow waveguide core 304 may be 1 mm.

In some embodiments, as shown in FIG. 3E, the first hollow waveguide 208a may be a photonic-bandgap fiber comprising a plurality of air channels 324 (hereinafter the “air channels 324”) periodically spaced throughout the conductive layer 316.

In other embodiments, the cross-section of the hollow waveguide core 304 may have an elliptical shape (i.e., having a first diameter x₁ along the x-axis and a second diameter y₁ along the y-axis, wherein the first diameter is not equal to the second diameter) (shown in FIG. 3F), a rectangular shape (shown in FIG. 3G) (i.e., having a first length x₁ along the x-axis and a second length y₁ along the y-axis, wherein the first length is not equal to the second length), a square shape (i.e., having a length l₁ that is equal along both the x-axis and the y-axis) (shown in FIG. 3H), or a cross shape (i.e., having a length l₁ that is equal along both the x-axis and the y-axis) (shown in FIG. 3I), for example.

In other embodiments, the first hollow waveguide 208a (and, therefore, any of the hollow waveguides 208) may be implemented as a solid rod fiber (shown in FIG. 3J), a microstructured optical fiber (shown in FIG. 3K), a porous fiber (shown in FIG. 3L), a suspended porous-core fiber (shown in FIG. 3M), a suspended slotted core fiber (shown in FIG. 3N), a hollow-core bandgap fiber (shown in FIG. 3O), a hollow-core tube fiber (shown in FIG. 3P), a hollow-core fiber with negative curvature (shown in FIG. 3Q), a hollow-core fiber based on anti-resonances and inhibited coupling (shown in FIG. 3R), a hollow-core nested anti-resonant nodeless fiber (shown in FIG. 3S), a 3D-printed hollow-core fiber based on anti-resonances and inhibited coupling (shown in FIG. 3T), or a Bragg fiber (shown in FIG. 3U), for example.

Referring now to FIG. 4A, shown therein is a block diagram of an exemplary embodiment of the first transmitter 212a shown in FIG. 2. However, it should be understood that the description of any particular one of the transmitter 212 may be applicable to any of the transmitters 212 described herein. The first transmitter 212a (and, therefore, each of the transmitters 212) generally comprises a client-side input 400 configured to receive one or more baseband signals 404 (hereinafter, the “baseband signals 404”) having client data encoded therein from one or more external component (e.g., a control module 224), transmitter circuitry 408 configured to receive the baseband signals 404 from the client-side input 400 and generate one or more antenna feed signals 412 (hereinafter, the “antenna feed signals 412”) based on the baseband signals 404, and one or more first antennas 416 configured to receive the antenna feed signals 412 from the transmitter circuitry 408, generate one or more radiated signals 420 (hereinafter, the “radiated signals 420”) based on the antenna feed signals 412, and couple the radiated signals 420 into the first hollow waveguide 208a.

In some embodiments, the client-side input 400 is a pair of inputs configured to receive a differential signal. In some such embodiments, the client-side input 400 may be a low voltage differential signaling (LVDS) link configured to receive LVDS signals, and the baseband signals 404 may be LVDS signals indicative of client data.

In some embodiments, the antenna feed signals 412 are provided to the first antennas 416 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 decibels (dB) per meter (m) per Terabit (Tb) per second(s).

In some embodiments, as shown in FIG. 4A, each of the client-side input 400, the transmitter circuitry 408, and the first antennas 416 may be disposed on a substrate 424. However, in other embodiments, one or more of the client-side input 400, the transmitter circuitry 408, and the first antennas 416 may be disposed on a first substrate (not shown), and one or more of the client-side input 400, the transmitter circuitry 408, and the first antennas 416 may not be disposed on the first substrate. For example, the one or more of the client-side input 400, the transmitter circuitry 408, and the first antennas 416 may be disposed on a second substrate (not shown). In such embodiments, the first substrate and the second substrate may be in a stacked arrangement.

In some embodiments, the substrate 424 may have a plurality of layers (not shown). In such embodiments, one or more of the client-side input 400, the transmitter circuitry 408, and the first antennas 416 may be disposed on a first layer (not shown), and one or more of the client-side input 400, the transmitter circuitry 408, and the first antennas 416 may be disposed on a second layer (not shown).

In some embodiments, one or more of the client-side input 400, the transmitter circuitry 408, and the first antennas 416 may be integrated into a monolithic semiconductor die (not shown). In some embodiments, one or more of the client-side input 400, the transmitter circuitry 408, and the first antennas 416 may implemented using one or more of complementary metal-oxide semiconductor (CMOS) technology, silicon-germanium (SiGe) semiconductor technology, and III-V compound semiconductor technology.

In some embodiments, the baseband signals 404 are digital bitstreams. In some embodiments, the client data may be encoded in the baseband signals 404 using an encoding protocol conforming to requirements of one or more of return-to-zero (RZ) code, non-return-to-zero (NRZ) code, pulse-amplitude modulation (PAM), and quadrature-amplitude modulation (QAM). In some embodiments, the client data may be encoded in the radiated signals 420 using an encoding protocol conforming to requirements of one or more of RZ, NRZ, quadrature phase-shift keying (QPSK), QAM, trellis coded modulation (TCM), and Bose-Chaudhuri-Hocquenghem (BCH) code.

In some embodiments, the radiated signals 420 include a first complementary radiated signal (not shown) having a first polarization and a second complementary radiated signal (not shown) having a second polarization different from the first polarization. In such embodiments, the first antennas 416 may be configured to generate the radiated signals 420 including the first complementary radiated signal and the second complementary radiated signal based on the antenna feed signals 412. The first polarization and the second polarization may be orthogonal to each other.

In some embodiments, each of the first polarization and the second polarization may be a linear polarization. In such embodiments, the first antennas 416 may include one or more of a differential waveguide probe antenna, a differential tapered antenna, and a differential patch antenna. In other embodiments, each of the first polarization and the second polarization may be a circular polarization. In such embodiments, the first antennas 416 may include one or more of a helix antenna and a spiral antenna.

In some embodiments, the radiated signals 420 include a first complementary radiated signal (not shown) having a first polarization and a second complementary radiated signal (not shown) having a second polarization different from the first polarization, and the first antennas 416 are further configured to couple the first complementary radiated signal and the second complementary radiated signal into the first hollow waveguide 208a such that the first complementary radiated signal and the second complementary radiated signal interact in the first hollow waveguide 208a to form the combined radiated signal (not shown) having a third polarization different from the first polarization and the second polarization. In such embodiments, the first antennas 416 may include an antenna array.

Referring now to FIG. 4B, in some embodiments, the first transmitter 212a (and, therefore, any of the transmitters 212) further comprises a first serializer 426 configured to receive a plurality of parallel baseband signals 428a-n (hereinafter, the “parallel baseband signals 428”) and combine the parallel baseband signals 428 into a serial baseband signal (i.e., the baseband signals 404). In such embodiments, the client-side input 400 may be configured to receive the baseband signals 404 from the first serializer 426. In some such embodiments, combining the parallel baseband signals 428 into the baseband signals 404 utilizes at least one of polarization division multiplexing (PDM), time division multiplexing (TDM), and wavelength division multiplexing (WDM).

Referring now to FIG. 4C, in some embodiments, the first transmitter 212a (and, therefore, any of the transmitters 212) further comprises a first deserializer 432 configured to receive a serial baseband signal (i.e., the baseband signals 404) and split the baseband signals 404 into parallel baseband signals 428. In such embodiments, the client-side input 400 may be configured to receive the parallel baseband signals 428 from the first deserializer 432. In some such embodiments, splitting the baseband signals 404 into the parallel baseband signals 428 utilizes at least one of PDM, TDM, and WDM.

Referring now to FIG. 4D, shown therein is an exemplary embodiment of the transmitter circuitry 408 shown in FIGS. 4A-4C. In some embodiments, the transmitter circuitry 408 comprises one or more local oscillators 436a-n (hereinafter, the “LO 436”) configured to generate one or more carrier signals 440 (hereinafter, the “carrier signals 440”) having a baseband frequency less than the transmission frequency, one or more modulation circuits 444 (hereinafter, the “modulator 444”) configured to receive the baseband signals 404 from the client-side input 400 and the carrier signals 440 from the LO 436 and modulate the baseband signals 404 onto the carrier signals 440 to generate one or more modulated signals 448 (hereinafter, the “modulated signals 448”), and one or more up-conversion circuits 452 (hereinafter, the “up-convertor 452”) configured to receive the modulated signals 448 from the modulator 444 and up-convert the modulated signals 448 (i.e., raise a frequency of the modulated signals 448 from the baseband frequency to the transmission frequency) to generate the antenna feed signals 412.

Referring now to FIG. 4E, in embodiments in which the client-side input 400 is configured to receive the parallel baseband signals 428, the transmitter circuitry 408 may be configured to receive the parallel baseband signals 428 from the client-side input 400. In such embodiments, the modulator 444 may be configured to receive the parallel baseband signals 428 from the client-side input 400 and the carrier signals 440 from first LO 436 and modulate the parallel baseband signals 428 onto the carrier signals 440 to generate the modulated signals 448. In such embodiments, the up-converter 452 may be configured to receive the modulated signals 448 from the modulator 444 and up-convert the modulated signals 448 to generate one or more up-converted signals 460 (hereinafter, the “up-converted signals 460”).

In some embodiments, the transmitter circuitry 408 may further comprise a combiner 456 configured to receive the up-converted signals 460 from the up-converter 452 and combine the up-converted signals 460 into the antenna feed signals 412. However, in other embodiments, the first antennas 416 may be configured to receive the antenna feed signals 412 from the up-converter 452, generate the radiated signals 420 based on the antenna feed signals 412, and couple the radiated signals 420 into the first hollow waveguide 208a such that the radiated signals 420 interact in the first hollow waveguide 208a to form a combined radiated signal (not shown).

In some embodiments, coupling the radiated signals 420 into the first hollow waveguide 208a such that the radiated signals 420 interact in the first hollow waveguide 208a to form the combined radiated signal utilizes at least one of PDM, TDM, and WDM.

Referring now to FIG. 4F, shown therein is a block diagram of another exemplary embodiment of the first transmitter 212a shown in FIG. 2. However, it should be understood that the description of any particular one of the transmitters 212 may be applicable to any of the transmitters 212 described herein.

In the embodiment shown in FIG. 4F, the first transmitter 212a comprises the client-side input 400 configured to receive the baseband signals 404 from one or more external component (e.g., a control module 224) and send the baseband signals 404 to the transmitter circuitry 408, the transmitter circuitry 408 configured to receive the baseband signals 404 from the client-side input 400, generate the antenna feed signals 412 based on the baseband signals 404, and send the antenna feed signals 412 to an RF interface 464 configured to receive the antenna feed signals 412 from the transmitter circuitry 408 and transmit the antenna feed signals 412, and a digital enhancement and control unit 468 configured to provide digital control and/or processing capabilities for one or more of the components of the first transmitter 212a.

In the embodiment shown in FIG. 4F, the transmitter circuitry 408 comprises one or more modulation block 444a (hereinafter, the “modulation block 444a”), a frequency synthesizer 472 comprising a phase-locked loop (PLL) 476 and a first LO 436a, a second LO 436b, a first frequency mixer 480a, a second frequency mixer 480b, a first amplifier 484a, and a second amplifier 484b.

The modulation block 444a may be configured to receive the baseband signals 404 from the client-side input 400 and encode the baseband signals 404 in a format suitable for modulation onto a carrier signal. In some embodiments, the modulation block 444a may include one or more digital-to-analog converter (DAC), one or more Serializer/Deserializer (SerDes), one or more folded modulator 700 (shown in FIG. 7), and/or circuitry operable to encode the baseband signals 404 in a modulation format, such as AM, ASK, PSK, QAM, QAM16, or variations thereof, for example. In some embodiments, the modulation block 444a may include circuitry operable to perform forward error correction (FEC). The modulation block 444a may be further configured to send the encoded input signals having the data encoded therein to the second frequency mixer 480b.

In some embodiments, the modulation block 444a is configured to simply receive the baseband signals 404 (i.e., the baseband signals 404 having been previously encoded in a modulation format) from the client-side input 400 and send the baseband signals 404 to the second frequency mixer 480b.

The second LO 436b may be configured to generate second carrier signals having a continuous waveform (e.g., a sinusoidal waveform) having a predetermined frequency (i.e., a baseband (BB) frequency). In some embodiments, the predetermined frequency of the second carrier signals (i.e., the BB frequency) is in an RF band (i.e., in a range between 30 Hertz (Hz) and 300 GHz). In some embodiments, the predetermined frequency of the second carrier signals (i.e., the BB frequency) is in a range between 1 Megahertz (MHz) and 300 GHz. In some embodiments, the predetermined frequency of the second carrier signals (i.e., the BB frequency) is in a range between 5 GHz and 30 GHz. The second LO 436b may be further configured to send the second carrier signals to the second frequency mixer 480b.

The second frequency mixer 480b may be configured to receive the encoded baseband signals from the modulation block 444a, receive the second carrier signals from the second LO 436b, up-convert the encoded baseband signals with the second carrier signals to produce first modulated signals having client data encoded therein and having the predetermined frequency of the second carrier signals (i.e., the BB frequency), and send the first modulated signals to the third amplifier 484c.

The third amplifier 484c may be configured to receive the first modulated signals from the second frequency mixer 480b, adjust an amplitude of the first modulated signals such that the amplified first modulated signals can drive the first frequency mixer 480a, and send the amplified first modulated signals to the first frequency mixer 480a.

The frequency synthesizer 472 (i.e., the first LO 436a and the PLL 476) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 472 may be further configured to send the first carrier signals to the second amplifier 484b.

The second amplifier 484b may be configured to receive the first carrier signals from the first LO 436a, adjust an amplitude of the first carrier signals to generate amplified carrier signals that can drive the first frequency mixer 480a, and send the amplified carrier signals to the first frequency mixer 480a.

The first frequency mixer 480a may be configured to receive the amplified carrier signals from the second amplifier 484b, receive the amplified first modulated signals from the third amplifier 484c, up-convert the amplified first modulated signals with the amplified carrier signals to produce second modulated signals having the client data encoded therein and having the predetermined frequency of the amplified carrier signals (i.e., within the THz frequency band 104 or, in some embodiments, in a range between 300 GHz and 10 THz), and send the second modulated signals to the first amplifier 484a.

The first amplifier 484a may be configured to receive the second modulated signals from the first frequency mixer 480a, adjust an amplitude of the second modulated signals such that the amplified second modulated signals can be transmitted by the RF interface 464, and send the amplified second modulated signals to the RF interface 464. The first amplifier 484a may be configured to generate the amplified second modulated signals to have a power in a range between 0.05 watts (W) and 0.4 W, for example.

The RF interface 464 may be configured to receive the amplified second modulated signals with the client data encoded therein from the first amplifier 484a and send the amplified second modulated signals as the antenna feed signals 412 (i.e., having the client data encoded therein) within a predetermined frequency range (e.g., the THz frequency band 104 or, in some embodiments, in a range between 300 GHz and 10 THz). In some embodiments, the RF interface 464 may be electrically connected to one of the first antennas 416 and configured to send the antenna feed signals 412 to the first antenna 416. In other embodiments, however, the first antennas 416 may be included in place of the RF interface 464.

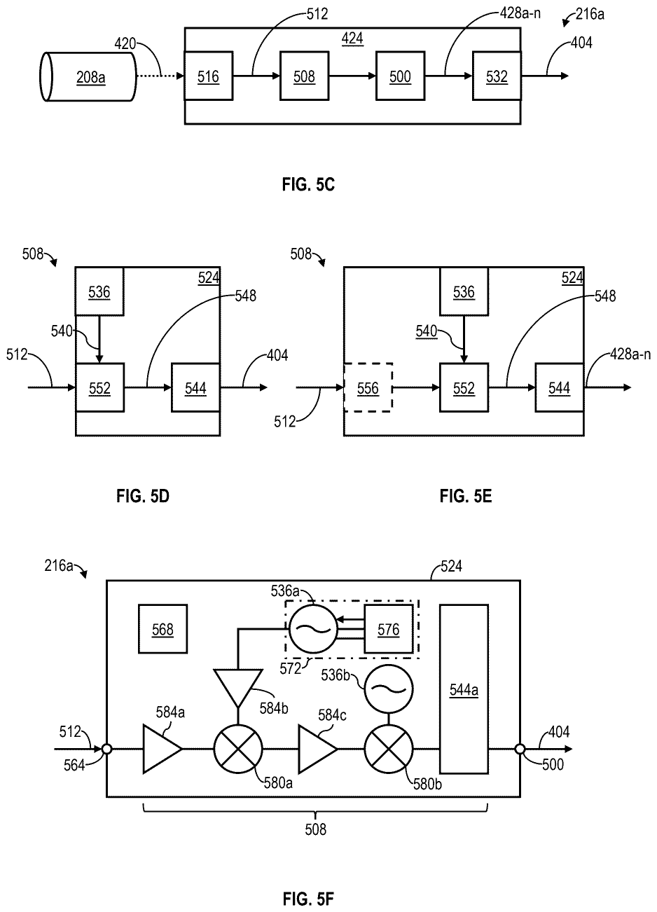

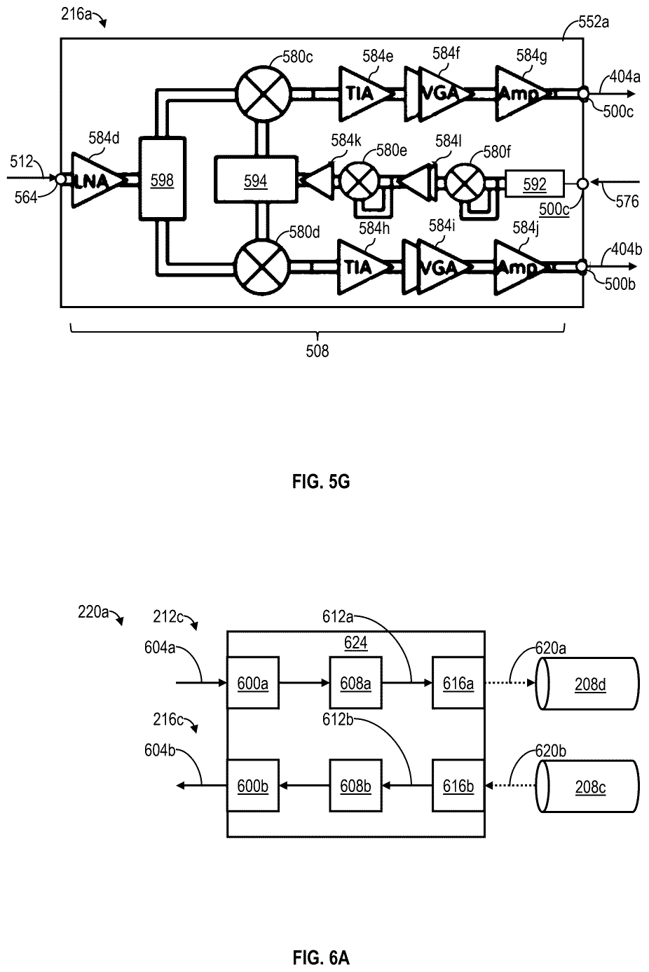

Referring now to FIG. 4G, shown therein is a block diagram of another exemplary embodiment of the first transmitter 212a shown in FIG. 2. In the embodiment shown in FIG. 5B, the first transmitter 212a comprises a plurality of inputs including an in-phase (I)-BB client-side input 400a and a quadrature (Q)-BB client-side input 400b configured to receive I-BB baseband signals 404a and Q-BB baseband signals 404b, respectively, from one or more external component (e.g., a control module 224) and an LO input 400c configured to receive one or more carrier signals 488 (hereinafter, the “carrier signals 488”) from an external LO, the transmitter circuitry 408 configured to generate the antenna feed signals 412 based on the I-BB baseband signals 404a, the Q-BB baseband signals 404b, and the carrier signals 488, and the RF interface 464 configured to transmit the antenna feed signals 412.

In the embodiment shown in FIG. 4G, the transmitter circuitry 408 comprises a balancing unit (Balun) 492, a third frequency mixer 480c, a fourth frequency mixer 480d, a fifth frequency mixer 480e, and a sixth frequency mixer 480f, a fourth amplifier 484d, a fifth amplifier 484e, a sixth amplifier 484f, a seventh amplifier 484g, and eighth amplifier 484h, a quadrature coupler (e.g., branchline coupler) 494, and a power combiner (e.g., Wilkinson power combiner) 498.

The I-BB baseband signals 404a and the Q-BB baseband signals 404b may be I and Q components of baseband signals 404 having client data encoded therein. The I-BB client-side input 400a may be configured to send the I-BB baseband signals 404a to the sixth amplifier 484f. The Q-BB client-side input 400b may be configured to send the Q-BB baseband signals 404b to the seventh amplifier 484g.

The LO input 400c may be configured to receive the carrier signals 488 from an external LO, the carrier signals 488 having a continuous waveform (e.g., a sinusoidal waveform) having a predetermined frequency. The LO input 400c may be further configured to send the carrier signals 488 to the Balun 492.

The Balun 492 may be configured to isolate and/or maintain impedance differences between balanced transmission lines and unbalanced transmission lines. The Balun 492 may be further configured to send the carrier signals 488 to the third frequency mixer 480c.

The third frequency mixer 480c may be configured to receive the carrier signals 488 from the Balun 492, multiply the carrier signals 488 (e.g., by a multiple of four), and send the multiplied carrier signals to the fourth amplifier 484d.

The fourth amplifier 484d may be configured to receive the multiplied carrier signals from the third frequency mixer 480c, adjust an amplitude of the multiplied carrier signals such that the amplified carrier signals can drive the fourth frequency mixer 480d, and send the amplified carrier signals to the fourth frequency mixer 480d.

The fourth frequency mixer 480d may be configured to receive the amplified carrier signals from the fourth amplifier 484d, multiply the amplified carrier signals (e.g., by a multiple of two), and send the remultiplied carrier signals to the fifth amplifier 484e.

The fifth amplifier 484e may be configured to receive the remultiplied carrier signals from the fourth frequency mixer 480d, adjust an amplitude of the remultiplied carrier signals such that the reamplified carrier signals can drive the quadrature coupler 494, and send the reamplified carrier signals to the quadrature coupler 494.

The sixth amplifier 484f may be configured to receive the I-BB baseband signals 404a from the I-BB client-side input 400a, adjust an amplitude of the I-BB baseband signals 404a such that the amplified I-BB input signals can drive the fifth frequency mixer 480e, and send the amplified I-BB signals to the fifth frequency mixer 480e.

The seventh amplifier 484g may be configured to receive the Q-BB baseband signals 404b from the Q-BB client-side input 400b, adjust an amplitude of the Q-BB baseband signals 404b such that the amplified Q-BB baseband signals 404b can drive the sixth frequency mixer 480f, and the amplified Q-BB signals to the sixth frequency mixer 480f.

The quadrature coupler 494 may be configured to receive the reamplified carrier signals from the fifth amplifier 484e, split the reamplified carrier signals into first carrier signals and second carrier signals, send the first carrier signals to the fifth frequency mixer 480e, and send the second carrier signals to the sixth frequency mixer 480f, wherein the first carrier signals and the second carrier signals are out of phase by 90°.

The fifth frequency mixer 480e may be configured to receive the amplified I-BB signals from the sixth amplifier 484f, receive the first carrier signals from the quadrature coupler 494, up-convert the amplified I-BB signals with the first carrier signals to produce I antenna feed signals having the I component of the client data encoded therein and having the predetermined frequency of the carrier signals 488, and send the I antenna feed signals to the power combiner 498.

The sixth frequency mixer 480f may be configured to receive the amplified Q-BB signals from the seventh amplifier 484g, receive the second carrier signals from the quadrature coupler 494, up-convert the amplified Q-BB signals with the second carrier signals to produce Q antenna feed signals having the Q component of the client data encoded therein and having the predetermined frequency of the carrier signals 488, and send the Q antenna feed signals to the power combiner 498.

The power combiner 498 may be configured to receive the I antenna feed signals from the fifth frequency mixer 480e, receive the Q antenna feed signals from the sixth frequency mixer 480f, combine the I antenna feed signals and the Q antenna feed signals to produce the antenna feed signals 412, and send the antenna feed signals 412 to the RF interface 464. In some embodiments, the RF interface 464 may be electrically connected to one of the first antennas 416 and configured to send the antenna feed signals 412 to the first antenna 416. In other embodiments, however, one of the first antennas 416 may be included in place of the RF interface 464.

Referring now to FIG. 5A, shown therein is a block diagram of an exemplary embodiment of the first receiver 216a (hereinafter, the “first receiver 216a”) shown in FIG. 2. However, it should be understood that the description of any particular one of the receivers 216 may be applicable to any of the receivers 216 described herein. The first receiver 216a (and, therefore, each of the receiver 216) generally comprises one or more second antennas 516 configured to coherently detect the radiated signals 420 received from the first hollow waveguide 208a and generate one or more antenna output signals 512 (hereinafter, the “antenna output signals 512”) based on the radiated signals 420, receiver circuitry 508 configured to receive the antenna output signals 512 from the second antennas 516 and generate the baseband signals 404 based on the antenna output signals 512, and a client-side output 500 configured to receive the baseband signals 404 from the receiver circuitry 508 and transmit the baseband signals 404 to one or more external component (e.g., a control module 224).

In some embodiments, the antenna output signals 512 are received from the second antennas 516 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 dB/m/Tb/s.

In some embodiments, as shown in FIG. 5A, each of the second antennas 516, the receiver circuitry 508, and the client-side output 500 may be disposed on a substrate 524. However, in other embodiments, one or more of the second antennas 516, the receiver circuitry 508, and the client-side output 500 may be disposed on a first substrate (not shown), and one or more of the second antennas 516, the receiver circuitry 508, and the client-side output 500 may not be disposed on the first substrate. For example, the one or more of the second antennas 516, the receiver circuitry 508, and the client-side output 500 may be disposed on a second substrate (not shown). In such embodiments, the first substrate and the second substrate may be in a stacked arrangement.

In some embodiments, the substrate 524 may have a plurality of layers (not shown). In such embodiments, one or more of the second antennas 516, the receiver circuitry 508, and the client-side output 500 may be disposed on a first layer (not shown), and one or more of the second antennas 516, the receiver circuitry 508, and the client-side output 500 may be disposed on a second layer (not shown).

In some embodiments, one or more of the second antennas 516, the receiver circuitry 508, and the client-side output 500 may be integrated into a monolithic semiconductor die (not shown). In some embodiments, one or more of the second antennas 516, the receiver circuitry 508, and the client-side output 500 may implemented using one or more of CMOS technology, SiGe semiconductor technology, and III-V compound semiconductor technology.

In some embodiments, the radiated signals 420 include a first complementary radiated signal (not shown) having a first polarization and a second complementary radiated signal (not shown) having a second polarization different from the first polarization. In such embodiments, the second antennas 516 may be configured to generate the antenna output signals 512 based on the radiated signals 420 including the first complementary radiated signal and the second complementary radiated signal. The first polarization and the second polarization may be orthogonal to each other.

In some embodiments, the radiated signals 420 may be formed by a first complementary radiated signal (not shown) having a first polarization and a second complementary radiated signal (not shown) having a second polarization different from the first polarization interacting in the first hollow waveguide 208a. In such embodiments, the radiated signals 420 may have a third polarization different from the first polarization and the second polarization. In such embodiments, the second antennas 516 may be configured generate the antenna output signals 512 based on the radiated signals 420 formed by the first complementary radiated signal and the second complementary radiated signal.

Referring now to FIG. 5B, in some embodiments, the client-side output 500 is configured to receive a serial baseband signal (i.e., the baseband signals 404) from the receiver circuitry 508. In such embodiments, the first receiver 216a (and, therefore, any of the receivers 216) may further comprise a second deserializer 526 configured to receive the baseband signals 404 from the client-side output 500, split the serial baseband signal into the parallel baseband signals 428, and transmit the parallel baseband signals 428 to one or more external component (e.g., a control module 224). In some such embodiments, splitting the serial baseband signal into the parallel baseband signals 428 utilizes at least one of PDM, TDM, and WDM.

Referring now to FIG. 5C, in some embodiments, the client-side output 500 is configured to receive the parallel baseband signals 428 from the receiver circuitry 508. In such embodiments, the first receiver 216a (and, therefore, any of the receivers 216) may further comprise a second serializer 532 configured to receive the parallel baseband signals 428 from the client-side output 500 and combine the parallel baseband signals 428 into the serial baseband signal (i.e., the baseband signals 404). In some such embodiments, combining the parallel baseband signals 428 into the baseband signals 404 utilizes at least one of PDM, TDM, and WDM.

Referring now to FIG. 5D, shown therein is an exemplary embodiment of the receiver circuitry 508 shown in FIGS. 5A-5C. In some embodiments, the receiver circuitry 508 comprises one or more LOs 536 (hereinafter, the “LO 536”) configured to generate one or more reference signals 540 (hereinafter, the “reference signals 540”) having a baseband frequency less than the transmission frequency, one or more down-conversion circuits 552 (hereinafter, the “down-converter 552”) configured to receive the antenna output signals 512 from the second antennas 516 and the reference signals 540 from the LO 536 and down-convert the antenna output signals 512 (i.e., lower a frequency of the antenna output signals 512 from the transmission frequency to the baseband frequency) using the reference signals 540 to generate one or more modulated signals 548 (hereinafter, the “modulated signals 548”), and one or more demodulation circuits 544 (hereinafter, the “demodulator 544”) configured to receive the modulated signals 548 from the down-converter 552 and demodulate the modulated signals 548 to generate the baseband signals 404.

Referring now to FIG. 5E, in embodiments in which the second antennas 516 are configured to receive the radiated signals 420 formed by a first complementary radiated signal (not shown) having a first polarization and a second complementary radiated signal (not shown) having a second polarization different from the first polarization interacting in the first hollow waveguide 208a, the receiver circuitry 508 may be configured to receive the antenna output signals 512 from the second antennas 516. In such embodiments, the demodulator 544 may be configured to receive the modulated signals 548 from the down-converter 552 and demodulate the modulated signals 548 to generate the parallel baseband signals 428.

In some embodiments, the receiver circuitry 508 may further comprise a splitter 556 configured to receive the antenna output signals 512 from the second antennas 516 and split the antenna output signals 512 into a plurality of parallel antenna output signals 560 (hereinafter, the “parallel antenna output signals 560”). However, in other embodiments, the second antennas 516 may be configured to coherently detect the first complementary radiated signal and the second complementary radiated signal based on the radiated signals 420 received from the first hollow waveguide 208a and generate the antenna output signals 512 based on the first complementary radiated signal and the second complementary radiated signal.

In some embodiments, detecting the first complementary radiated signal and the second complementary radiated signal based on the radiated signals 520 received from the first hollow waveguide 208a utilizes at least one of PDM, TDM, and WDM.

Referring now to FIG. 5F, shown therein is a block diagram of another exemplary embodiment of the first receiver 216a shown in FIG. 2. In the embodiment shown in FIG. 5F, the first receiver 216a comprises an RF interface 564 configured to receive the antenna output signals 512, the receiver circuitry 508 configured to generate the baseband signals 404 based on the antenna output signals 512, the client-side output 500 configured to transmit the baseband signals 404 to one or more external component (e.g., a control module 224), and a digital enhancement and control unit 568 configured to provide digital control and/or processing capabilities for one or more of the components of the first receiver 216a.

In the embodiment shown, the receiver circuitry 508 comprises one or more demodulation block 544a (hereinafter, the “demodulation block 544a”), a frequency synthesizer 572 comprising a PLL 576 and a first LO 536a, a second LO 536b, a first frequency mixer 580a, a second frequency mixer 580b, a first amplifier 584a, a second amplifier 584b, and a third amplifier 584c.

The RF interface 564 may be configured to send the antenna output signals 512 to the first amplifier 584a. In some embodiments, the RF interface 564 may be configured to receive the antenna output signals 512 from one of the second antennas 516. In other embodiments, one of the second antennas 516 may be included in place of the RF interface 564.

The first amplifier 584a may be configured to receive the antenna output signals 512 from the RF interface 564, adjust an amplitude of the antenna output signals 512 such that the amplified transmission signals can drive the first frequency mixer 580a, and send the amplified transmission signals to the first frequency mixer 580a.

The frequency synthesizer 572 (i.e., the first LO 536a and the PLL 576) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The first LO 536a may be further configured to send the first carrier signals to the second amplifier 584b.

The second amplifier 584b may be configured to receive the first carrier signals from the first LO 536a, adjust an amplitude of the first carrier signals to generate amplified carrier signals that can drive the first frequency mixer 580a, and send the amplified carrier signals to the first frequency mixer 580a.

The first frequency mixer 580a may be configured to receive the antenna output signals 512 from the first amplifier 584a, receive the amplified carrier signals from the second amplifier 584b, down-convert the antenna output signals 512 with the amplified carrier signals to produce modulated signals having the client data encoded therein and having the BB frequency, and send the modulated signals to the third amplifier 584c.

The third amplifier 584c may be configured to receive the modulated signals from the first frequency mixer 580a, adjust an amplitude of the modulated signals such that the amplified modulated signals can drive the second frequency mixer 580b, and send the amplified modulated signals to the second frequency mixer 580b.

The second LO 536b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 536b may be further configured to send the second carrier signals to the second frequency mixer 580b.

The second frequency mixer 580b may be configured to receive the amplified modulated signals from the third amplifier 584c, receive the second carrier signals from the second LO 536b, down-convert the amplified modulated signals with the second carrier signals to produce encoded signals having the client data encoded therein and having the predetermined frequency of the second carrier signals (i.e., the BB frequency), and send the encoded signals to the demodulation block 544a.

The demodulation block 544a may be configured to receive the encoded signals from the second frequency mixer 580b and decode the encoded signals in a format suitable for transmission to one or more external component (e.g., a control module 224) to generate the baseband signals 404.

In some embodiments, the demodulation block 544a may include one or more analog-to-digital converter (ADC), one or more SerDes, one or more rectifying detector 800 (shown in FIG. 8), and/or circuitry operable to decode the encoded output signals from a modulation format, such as AM, ASK, PSK, QAM, or QAM16, or variations thereof, for example, to produce the baseband signals 404 with the client data encoded therein. In some embodiments, the demodulation block 544a may include circuitry operable to perform forward error correction (FEC). The demodulation block 544a may be further configured to send the baseband signals 404 to the client-side output 500. In some embodiments, the demodulation block 544a is configured to simply receive the encoded signals from the second frequency mixer 580b and send the encoded signals as the baseband signals 404 to the client-side output 500.

In some embodiments, the client-side output 500 is a pair of output interfaces. In some such embodiments, the client-side output 500 is an LVDS link configured to transmit LVDS signals, and the baseband signals 404 are LVDS signals with the client data encoded therein.

Referring now to FIG. 5G, shown therein is a block diagram of another exemplary embodiment of the first receiver 216a shown in FIG. 2. In the embodiment shown in FIG. 5G, the first receiver 216a comprises the RF interface 564 configured to receive the antenna output signals 512, an LO input 500c configured to receive carrier signals 588 from an external LO, the receiver circuitry 508 configured to generate Q-BB baseband signals 404b and I-BB baseband signals 404a based on the antenna output signals 512 and the carrier signals 588, and a Q-BB client-side output 500a and an I-BB client-side output 500b configured to transmit the Q-BB baseband signals 404b and the I-BB baseband signals 404a, respectively.

In the embodiment shown, the receiver circuitry 508a comprises a third frequency mixer 580c, a fourth frequency mixer 580d, a fifth frequency mixer 580e, a sixth frequency mixer 580f, a fourth amplifier 584d, a fifth amplifier 584e, a sixth amplifier 584f, a seventh amplifier 584g, an eighth amplifier 584h, a ninth amplifier 584i, a tenth amplifier 584j, an eleventh amplifier 584k, a twelfth amplifier 584l, a Balun 592, a quadrature coupler (e.g., branchline coupler) 594, and a power divider (e.g., Wilkinson power divider) 598.

The fourth amplifier 584d may be configured to receive the antenna output signals 512 from the RF interface 564, adjust an amplitude of the antenna output signals 512 such that the amplified transmission signals can drive the power divider 598, and send the amplified transmission signals to the power divider 598. In some embodiments, the fourth amplifier 584d is a low-noise amplifier (LNA).

The power divider 598 may be configured to receive the amplified transmission signals from the fourth amplifier 584d, split the amplified transmission signals into I antenna output signals having the I component of the client data encoded therein and Q antenna output signals having the Q component of the client data encoded therein, send the Q antenna output signals to the third frequency mixer 580c, and send the I antenna output signals to the fourth frequency mixer 580d.

The LO input 500c may be configured to receive carrier signals 588 from an external LO, the carrier signals 588 having a continuous waveform (e.g., a sinusoidal waveform) having a predetermined frequency. The LO input 500c may be further configured to send the carrier signals 588 to the Balun 592.

The Balun 592 may be configured to isolate and/or maintain impedance differences between balanced transmission lines and unbalanced transmission lines. The Balun 492 may be further configured to send the carrier signals 588 to the sixth frequency mixer 580f.

The sixth frequency mixer 580f may be configured to receive the carrier signals 588 from the Balun 592, multiply the carrier signals 588 (e.g., by a multiple of four), and send the multiplied carrier signals to the twelfth amplifier 584l.

The twelfth amplifier 584l may be configured receive the multiplied carrier signals from the sixth frequency mixer 580f, adjust an amplitude of the multiplied carrier signals to generate amplified carrier signals that can drive the fifth frequency mixer 580e, and send the amplified carrier signals to the fifth frequency mixer 580e.

The fifth frequency mixer 580e may be configured to receive the amplified carrier signals from the twelfth amplifier 584l, multiply the amplified carrier signals (e.g., by a multiple of two), and send the remultiplied carrier signals to the eleventh amplifier 584k.

The eleventh amplifier 584k may be configured to receive the remultiplied carrier signals from the fifth frequency mixer 580e, adjust an amplitude of the remultiplied carrier signals to generate reamplified carrier signals that can drive the quadrature coupler 594, and send the reamplified carrier signals to the quadrature coupler 594.

The quadrature coupler 594 may be configured to receive the reamplified carrier signals from the eleventh amplifier 584k, split the reamplified carrier signals into first carrier signals and second carrier signals, send the first carrier signals to the third frequency mixer 580c, and send the second carrier signals to the fourth frequency mixer 580d, wherein the first carrier signals and the second carrier signals are out of phase by 90°.

The third frequency mixer 580c may be configured to receive the Q antenna output signals from the power divider 598, receive the first carrier signals from the quadrature coupler (e.g., branchline coupler) 566, down-convert the Q antenna output signals with the first carrier signals to generate Q-BB intermediate signals having the Q component of the client data encoded therein and having the BB frequency, and send the Q-BB intermediate signals to the fifth amplifier 584e.

The fifth amplifier 584e, the sixth amplifier 584f, and the seventh amplifier 584gmay be configured to receive the Q-BB intermediate signals from the third frequency mixer 580c, down-convert the Q-BB intermediate signals to generate the Q-BB baseband signals 404b, and send the Q-BB baseband signals 404b to the Q-BB client-side output 500a. In some embodiments, the fifth amplifier 584e is a transimpedance amplifier (TIA), and the sixth amplifier 584f is a variable-gain amplifier (VGA).

The fourth frequency mixer 580d may be configured to receive the I antenna output signals from the power divider 598, receive the second carrier signals from the quadrature coupler 594, down-convert the I antenna output signals with the second carrier signals to produce I-BB intermediate signals having the I component of the client data encoded therein and having the BB frequency, and send the I-BB intermediate signals to the eighth amplifier 584h.

The eighth amplifier 584h, the ninth amplifier 584i, and the tenth amplifier 584j may be configured to receive the I-BB intermediate signals from the fourth frequency mixer 580d, down-convert the I-BB intermediate signals to generate the I-BB baseband signals 404a, and send the I-BB baseband signals 404a to the I-BB client-side output 500b. In some embodiments, the eighth amplifier 584h is a TIA, and the ninth amplifier 584i is VGA.

Referring now to FIG. 6A, shown therein is a block diagram of an exemplary embodiment of the first transceiver 220a (hereinafter, the “first transceiver 220a”) shown in FIG. 2. However, it should be understood that the description of any particular one of the transceivers 220 may be applicable to any of the transceivers 220 described herein. The first transceiver 220a (and, therefore, each of the transceivers 220) generally comprises a third transmitter 212c and a third receiver 216c.

The third transmitter 212c generally comprises a client-side input 600a configured to receive one or more first baseband signals 604a (hereinafter, the “first baseband signals 604a”) having first client data encoded therein from one or more external component (e.g., a control module 224), transmitter circuitry 608a configured to receive the first baseband signals 604a from the client-side input 600a and generate one or more antenna feed signals 612a (hereinafter, the “antenna feed signals 612”) based on the first baseband signals 604a, and one or more first antennas 616a (hereinafter, the “first antennas 616”) configured to receive the antenna feed signals 612a from the transmitter circuitry 608a, generate one or more first radiated signals 420a (hereinafter, the “first radiated signals 420a”) based on the antenna feed signals 612a, and couple the first radiated signals 420a into the fourth hollow waveguide 208d.

The third receiver 216c generally comprises one or more second antennas 616b (hereinafter, the “antennas 616b”) configured to coherently detect one or more second radiated signals 620b (hereinafter, the “second radiated signals 620b”) received from the third hollow waveguide 208c and generate one or more antenna output signals 612b (hereinafter, the “antenna output signals 612b”) based on the second radiated signals 620b, receiver circuitry 608b configured to receive the antenna output signals 612b from the second antennas 616b and generate the second baseband signals 604b based on the antenna output signals 612b, and a client-side output 600b configured to receive the second baseband signals 604b from the receiver circuitry 608b and transmit the second baseband signals 604b to one or more external component (e.g., a control module 224).

Each of the components of the first transceiver 220a (and, therefore, each of the transceivers 220) may be the same or similar to one or more of the components of the first transmitter 212a and the first receiver 216a as described herein.

Referring now to FIG. 6B, shown therein is a block diagram of another exemplary embodiment of the first transceiver 220a shown in FIG. 2. In the embodiment shown in FIG. 6B, the first transceiver 220a comprises the client-side input 600a configured to receive the first baseband signals 604a from one or more external component (e.g., a control module 224), the transmitter circuitry 608a configured to generate the antenna feed signals 612a based on the input signals 640a, a first RF interface 664a configured to transmit the antenna feed signals 612a, a second RF interface 664b configured to receive the antenna output signals 612b, the receiver circuitry 608b configured to generate the second baseband signals 604b based on the antenna output signals 612b, the client-side output 600b configured to transmit the second baseband signals 604b to one or more external component, and a digital enhancement and control unit 668 configured to provide digital control and/or processing capabilities for one or more of the components of the first transceiver 220a.

In some embodiments, the first transceiver 220a comprises the first RF interface 664a, but lacks the second RF interface 664b. In such embodiments, the first RF interface 664a may be configured to transmit antenna feed signals 612a and receive antenna output signals 612b. In some embodiments, the first transceiver 220a may have a number of RF interfaces that is greater than two.

In the embodiment shown, the transmitter circuitry 608a comprises a frequency synthesizer 672 comprising a PLL 676, a first LO 636a, and a signal distribution block (e.g., splitter) 698, one or more modulation block 644a (hereinafter, the “modulation block 644a”), a second LO 636b, a first frequency mixer 680a, a third frequency mixer 680c, a first amplifier 684a, a third amplifier 684c, and a fifth amplifier 684e.

In the embodiment shown, the receiver circuitry 608b comprises the frequency synthesizer 672 comprising the PLL 676, the first LO 636a, and the signal distribution 698, the modulation block 644a, a third LO 636c, a second frequency mixer 680b, a fourth frequency mixer 680d, a second amplifier 684b, a fourth amplifier 684d, and a sixth amplifier 684f.

In some embodiment shown in FIG. 6B, each of the components of the first transceiver 220a are disposed on a single substrate 624, which may be a portion of a semiconductor wafer.

The modulation block 644a may be configured to: (1) receive the first baseband signals 604a from the client-side input 600a, encode the first baseband signals 604a in a format suitable for modulation onto a carrier signal, and send the encoded input signals the third frequency mixer 680c; and (2) receive the encoded output signals from the fourth frequency mixer 680d, decode the encoded output signals in a format suitable for transmission to one or more external component (e.g., a control module 224), and send the second baseband signals 604b to the client-side output 600b.

In some embodiments, the modulation block 644a may include one or more DAC, one or more ADC, one or more Serializer/Deserializer (SerDes), one or more folded modulator 700 (shown in FIG. 7), one or more rectifying detector 800 (shown in FIG. 8) and/or circuitry operable to encode the first baseband signals 604a in a modulation format, such as AM, ASK, PSK, QAM, or QAM16, or variations thereof, for example, and decode encoded output signals from the modulation format to produce second baseband signals 604b having the client data encoded therein. In some embodiments, the modulation block 644a may include circuitry operable to perform forward error correction (FEC).

The frequency synthesizer 672 may be configured to generate first carrier signals having a continuous waveform (e.g., a sinusoidal waveform) having a predetermined frequency (e.g., within the THz frequency band 104 or in some embodiments, a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 672 may be further configured to send the first carrier signals to the signal distribution block 698.

The signal distribution block 698 may be configured to receive the first carrier signals from the first LO 636a and distribute the first carrier signals to the third amplifier 684c and the fourth amplifier 684d.

Referring now to the transmitter circuitry 608a, in some embodiments, the client-side input 600a is a pair of input interfaces. In some such embodiments, the client-side input 600a is an LVDS link configured to receive LVDS signals, and the first baseband signals 604a are LVDS signals having the client data encoded therein. The client-side input 600a may be further configured to send the first baseband signals 604a to the modulation block 644a.

The second LO 636b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 636b may be further configured to send the second carrier signals to the third frequency mixer 680c.

The third frequency mixer 680c may be configured to receive the encoded input signals from the modulation block 644a, receive the second carrier signals from the second LO 636b, up-convert the encoded input signals with the second carrier signals to produce first modulated signals having the client data encoded therein and having the predetermined frequency of the second carrier signals (i.e., the BB frequency), and send the first modulated signals to the fifth amplifier 684e.

The fifth amplifier 684e may be configured to receive the first modulated signals from the third frequency mixer 680c, adjust an amplitude of the first modulated signals such that the amplified first modulated signals can drive the first frequency mixer 680a, and send the amplified first modulated signals to the first frequency mixer 680a.

The third amplifier 684c may be configured to receive the first carrier signals from the signal distribution block 698, adjust an amplitude of the first carrier signals to generate amplified carrier signals that can drive the first frequency mixer 680a, and send the amplified carrier signals to the first frequency mixer 680a.

The first frequency mixer 680a may be configured to receive the amplified carrier signals from the third amplifier 684c, receive the amplified first modulated signals from the fifth amplifier 684e, up-convert the amplified first modulated signals with the amplified carrier signals to produce second modulated signals having the data encoded therein and having the predetermined frequency of the amplified carrier signals (i.e., within the THz frequency band 104 or, in some embodiments, in a range between 300 GHz and 10 THz), and send the second modulated signals to the first amplifier 684a.

The first amplifier 684a may be configured to receive the second modulated signals from the first frequency mixer 680a, adjust an amplitude of the second modulated signals such that the amplified second modulated signals can be transmitted by the first RF interface 664a, and send the amplified second modulated signals to the first RF interface 664a.

The first RF interface 664a may be configured to receive the amplified second modulated signals from the first amplifier 684a and send the amplified second modulated signals as antenna feed signals 612a (i.e., having the data encoded therein) having a frequency within a predetermined frequency range (e.g., the THz frequency band 104 or, in some embodiments, in a range between 300 GHz and 10 THz). In some embodiments, the first RF interface 664a may be connected to one of the antennas 616 and configured to send the antenna feed signals 612a to the antenna 616. In other embodiments, however, one of the antennas 616 may be included in place of the first RF interface 664a.

Referring now to the receiver circuitry 608b, the second RF interface 664b may be configured to receive the antenna output signals 612b (i.e., having client data encoded therein) within a predetermined frequency range (e.g., the THz frequency band 104 or, in some embodiments, in a range between 300 GHz and 10 THz) and send the antenna output signals 612b to the second amplifier 684b. As described in further detail below, the second RF interface 664b may be configured to receive the antenna output signals 612b from one of the antennas 616. In other embodiments, however, one of the antennas 616 may be included in place of the second RF interface 664b.

The second amplifier 684b may be configured to receive the antenna output signals 612b from the second RF interface 664b, adjust an amplitude of the antenna output signals 612b to generate amplified second transmission signals that can drive the second frequency mixer 680b, and send the amplified second transmission signals to the second frequency mixer 680b.

The fourth amplifier 684d may be configured to receive the first carrier signals from the signal distribution block 698, adjust an amplitude of the first carrier signals to generate amplified carrier signals that can drive the second frequency mixer 680b, and send the amplified carrier signals to the second frequency mixer 680b.

The second frequency mixer 680b may be configured to receive the amplified second transmission signals from the second amplifier 684b, receive the amplified carrier signals from the fourth amplifier 684d, down-convert the amplified second transmission signals with the amplified carrier signals to produce third modulated signals having the data encoded therein and having the IF or the BB frequency, and send the third modulated signals to the sixth amplifier 684f.

The sixth amplifier 684f may be configured to receive the third modulated signals from the second frequency mixer 680b, adjust an amplitude of the third modulated signals such that the amplified third modulated signals can drive the fourth frequency mixer 680d, and send the amplified third modulated signals to the fourth frequency mixer 680d.

The third LO 636c may be configured to generate reference signals having a continuous waveform (e.g., a sinusoidal waveform) having a predetermined frequency (i.e., a BB frequency). In some embodiments, the predetermined frequency of the reference signals (i.e., the BB frequency) is in a range between 8 GHz and 10 GHz. The third LO 636c may be further configured to send the reference signals to the fourth frequency mixer 680d.

The fourth frequency mixer 680d may be configured to receive the amplified third modulated signals from the sixth amplifier 684f, receive the reference signals from the third LO 636c, down-convert the amplified third modulated signals with the reference signals to produce encoded output signals having the client data encoded therein and having the predetermined frequency of the reference signals (i.e., the BB frequency), and send the encoded output signals to the modulation block 644a.

The client-side output 600b may be configured to transmit the second baseband signals 604b having the client data encoded therein to one or more external component (e.g., a control module 224). In some embodiments, the client-side output 600b is a pair of output interfaces. In some such embodiments, the client-side output 600b is an LVDS link configured to transmit LVDS signals, and the second baseband signals 604b are LVDS signals having the client data encoded therein.

Referring now to FIG. 7, shown therein is a schematic diagram of an exemplary embodiment of a folded modulator 700 constructed in accordance the present disclosure. The folded modulator 700 may be configured to perform broadband direct modulation to generate the encoded signals and to minimize distortion while doing so. The folded modulator 700 may employ a cascade architecture (e.g., a cascaded circuit drive that is “stacked” or “folded”) in order to produce a linear or near-linear modulated output (i.e., the encoded signals). In embodiments in which the folded modulator 700 employs a cascade architecture, the size of the stack may be directly proportional to the bandwidth.

Referring now to FIG. 8, shown therein is a schematic diagram of an exemplary embodiment of a rectifying detector 800 constructed in accordance the present disclosure. The rectifying detector 800 may be configured to perform direct detection of incoming signals (i.e., the encoded signals). The rectifying detector 800 may be further configured to detect an envelope of the encoded signals or one or more amplitude transition of the encoded signals to generate the output signals.

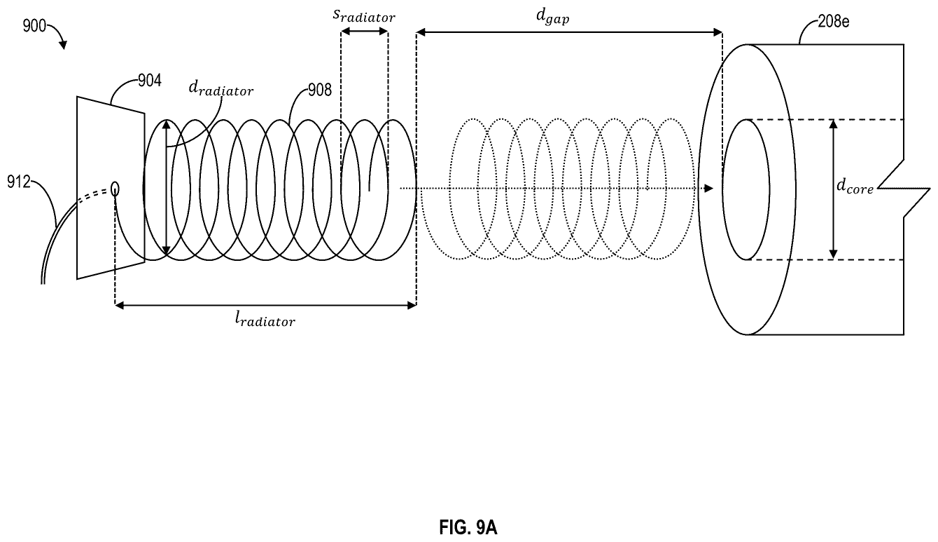

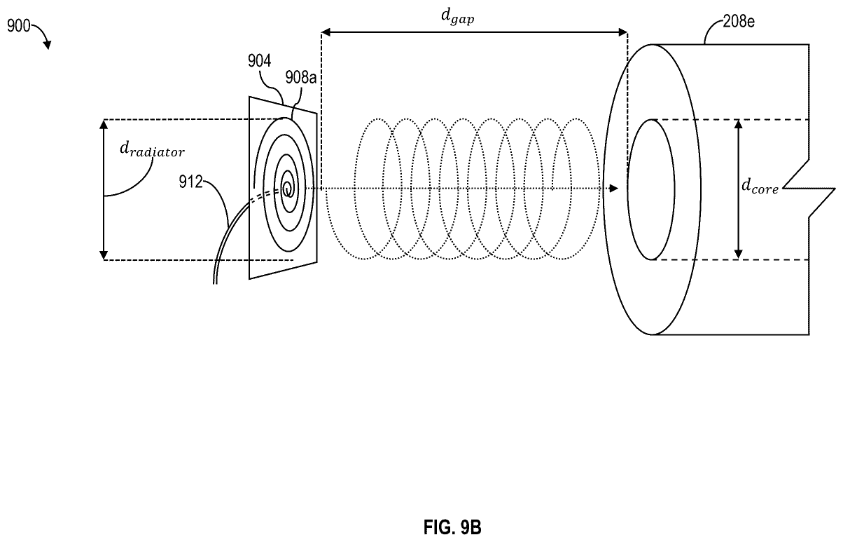

Referring now to FIG. 9A, shown therein is a side view of an exemplary embodiment of an antenna 900 coupled with a fifth hollow waveguide 208e constructed in accordance with the present disclosure. However, it should be understood that the description referring to any particular one of the antennas 416, 516, 616, 900, 1700, 1704 may refer to any of the antennas 416, 516, 616, 900, 1700, 1704 described herein. As shown in FIG. 8A, the antenna 900 generally comprises a ground plane 904, a radiator 908 mounted on the ground plane 904, and a coaxial feedline 912 electrically connected to the radiator 908. In some embodiments, the antenna 900 may lack the ground plane 904. In some embodiments, the antenna 900 further comprises a casing (not shown) enclosing the radiator 908. The antenna 900 may be a vertical antenna (i.e., an antenna extending orthogonally from a substrate) or a horizontal antenna (i.e., an antenna extending laterally from a substrate).

The radiator 908 may be configured to transmit and detect radiated signals configured for coherent detection. In the embodiment shown, the radiator 908 is a helical radiator configured to transmit and detect radiated signals having a circular polarization. In this embodiment, the radiator 908 has a length l_{radiator}, a diameter d_{radiator}, and a spacing s_{radiator} between adjacent turns of the radiator 908. The radiator 908 is preferably disposed at a distance d_{gap} from the fifth hollow waveguide 208e.

The radiator 908 may be wound in a predetermined direction, such as clockwise (i.e., a left-hand wind) or counter-clockwise (i.e., a right-hand wind). While the radiator 908 of the antenna 900 is depicted in FIG. 9A as having a right-hand wind or a counter-clockwise rotational direction, it should be understood that the radiator 908 of the antenna 900 may be provided with a left-hand wind or a clockwise rotational direction.

In some embodiments, signals for transmission may be sent to the antenna 900 via the coaxial feedline 912. In other embodiments, received RF signals may be sent from the antenna 900 via the coaxial feedline 912.

In some embodiments, the length l_{radiator} of the radiator 908 may be proportional to the wavelength of the signals being transmitted and/or received. In some embodiments, the length l_{radiator} of the radiator 908 is in a range between 10 microns and 10 mm. In some embodiments, the diameter d_{radiator} of the radiator 908 may be proportional to the wavelength of the signals being transmitted and/or received. In some embodiments, the diameter d_{radiator} of the radiator 908 is in a range between 10 microns and 10 mm. In some embodiments, the spacing s_{radiator} between adjacent turns of the radiator 908 may be in a range between 1 micron and 1 mm.

The predetermined distance d_{gap} at which the antenna 900 is spaced from the hollow waveguide 208 may vary depending upon the carrier frequency of the RF signal being transmitted by the antenna 900. In some embodiments, the predetermined distance d_{gap} at which the antenna 900 is spaced from the hollow waveguide 208 is in a range between 3 μm and 3 mm. In one embodiment, the predetermined distance d_{gap} at which the antenna 900 is spaced from the hollow waveguide 208 is 1 mm. In some embodiments, the antenna 900 may be directly connected to the fifth hollow waveguide 208e.

Referring now to FIG. 9B, shown therein is a top plan view of another exemplary embodiment of the antenna 900 coupled with the fifth hollow waveguide 208e constructed in accordance with the present disclosure. The antenna 900 is similar in construction and function as the antenna 900, with the exception that the antenna 900 includes a first radiator 908a formed of a conductive material having a plurality of coplanar windings. In one embodiment, the first radiator 908a is in the form of a spiral. The first radiator 908a may be wound in a predetermined direction, such as clockwise (i.e., a left-hand wind) or counter-clockwise (i.e., a right-hand wind). While the first radiator 908a of the antenna 900 is depicted in FIG. 9B as having a right-hand wind or a counter-clockwise rotational direction, it should be understood that the first radiator 908a of the antenna 900 may be provided with a left-hand wind or a clockwise rotational direction.

Other embodiments of the antenna 900 include embodiment as a gain horn antenna, a Cassegrain antenna, an omnidirectional antenna, a horn lens antenna, a spot focus antenna, a waveguide probe antenna, a scalar feed horn antenna, a wide-angle scalar feed horn antenna, a trihedral antenna, and a conical horn antenna.

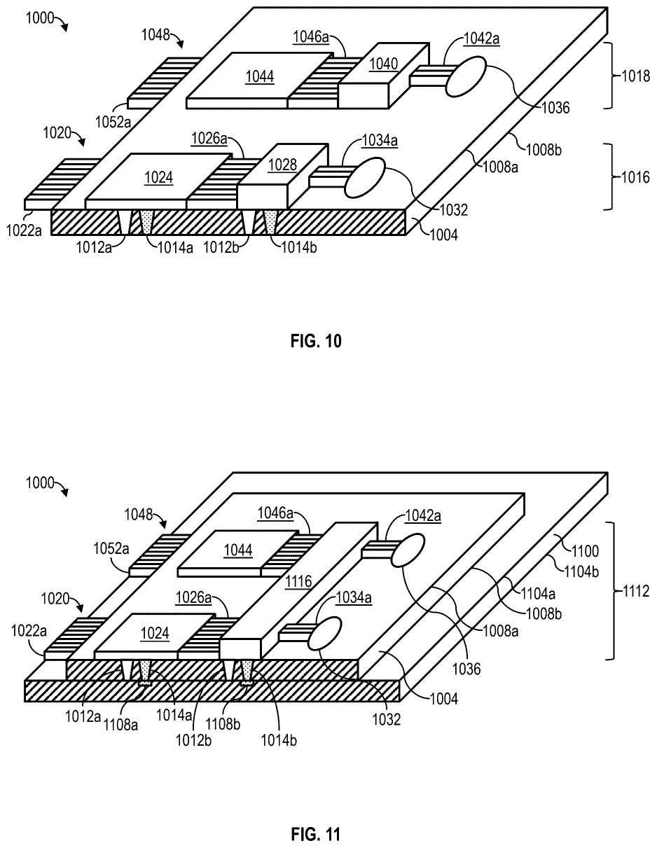

Referring now to FIG. 10, shown therein is an exemplary embodiment of a transceiver 1000 constructed in accordance with the present disclosure. As shown in FIG. 10, the transceiver 1000 may comprise an interposer substrate 1004 having a first interposer surface 1008a and a second interposer surface 1008b and defining a plurality of vias (hereinafter, the “vias”) including one or more thermal vias 1012a-n (hereinafter, the “thermal vias 1012”) and one or more through-silicon vias (TSVs) 1014a-n (hereinafter, the “TSVs 1014”) extending between the first interposer surface 1008a and the second interposer surface 1008b. The transceiver 1000 may further comprise a transmitter module 1016 and a receiver module 1018. Each of the thermal vias 1012 may be configured to conduct heat away from the first interposer surface 1008a and toward the second interposer surface 1008b, while each of the TSVs 1014 may be configured to route signals between the first interposer surface 1008a and the second interposer surface 1008b. In some embodiments, the thermal vias 1012 are filled with a metal, such as one or more of tungsten (W) and gold (Au), for example.

In some embodiments, the interposer substrate 1004 may be a passive interposer. That is, in such embodiments, the interposer substrate 1004 may include passive means for electrically coupling the components of the transceiver 1000 to one another, such as the TSVs 1014, without including any active components (e.g., transistors, resistors, capacitors, buffers, voltage regulators, signal repeaters or amplifiers, etc.) in the interposer substrate 1004 itself. However, in other embodiments, the interposer substrate 1004 may be an active interposer. That is, in such embodiments, the interposer substrate 1004 may further include one or more active components operable to modify and/or condition signals as they pass through the interposer substrate 1004. In some such embodiments, the active components may be operable to provide SerDes and/or control functionality for the transceiver 1000.

The transmitter module 1016 may comprise a client-side input 1020 comprising a plurality of input conductive traces 1022a-n (hereinafter, the “input traces 1022”). For purposes of clarity, only one of the input traces 1022 (i.e., input trace 1022a) is labeled with a reference character. At least two of the input traces 1022 may be operable to receive one or more outbound baseband signals (hereinafter, the “outbound baseband signals”) from a remote source, wherein each of the outbound baseband signals has outbound client data encoded therein and an outbound baseband frequency.

It should be understood that, in some embodiments, the at least two input traces 1022 may be operable to receive the outbound baseband signals from the remote source as single-ended signals. That is, in such embodiments, only one of the at least two input traces 1022 may be electrically coupled to the remote source to receive the outbound baseband signals, while another one of the at least two input traces 1022 may be electrically coupled to a common ground.

The transmitter module 1016 may further comprise a baseband transmitter circuit 1024 disposed on the first interposer surface 1008a and operable to receive the outbound baseband signals from the at least two input traces 1022 of the client-side input 1020 and generate one or more outbound intermediate signals (hereinafter, the “outbound intermediate signals”) based on the outbound baseband signals, wherein each of the outbound intermediate signals has an outbound intermediate frequency greater than the outbound baseband frequency of the corresponding outbound baseband signal (i.e., the outbound baseband signal upon which a particular outbound intermediate signal is based).

The transmitter module 1016 may further comprise an up-conversion circuit 1028 disposed on the first interposer surface 1008a and operable to receive the outbound intermediate signals from the baseband transmitter circuit 1024 and generate one or more antenna feed signals (hereinafter, the “antenna feed signals”) based on the outbound intermediate signals, wherein each of the antenna feed signals has an outbound transmission frequency greater than the outbound intermediate frequency of the corresponding outbound intermediate signal (i.e., the outbound intermediate signal upon which a particular antenna feed signal is based). The outbound transmission frequency may be in a range between 300 GHz and 10 THz.

In some embodiments, the transmitter module 1016 may further comprise one or more baseband transmitter conductive traces 1026a-n (hereinafter, the “baseband transmitter traces 1026”) disposed on the first interposer surface 1008a. For purposes of clarity, only one of the baseband transmitter traces 1026 (i.e., baseband transmitter trace 1026a) is labeled with a reference character. The baseband transmitter traces 1026 may extend between—and may be electrically coupled to—the baseband transmitter circuit 1024 and the up-conversion circuit 1028. At least two of the baseband transmitter traces 1026 may be operable to receive the outbound intermediate signals from the baseband transmitter circuit 1024, and the up-conversion circuit 1028 may be operable to receive the outbound intermediate signals from the baseband transmitter circuit 1024 via the at least two baseband transmitter traces 1026.

It should be understood that, in some embodiments, the at least two baseband transmitter traces 1026 may be operable to receive the outbound intermediate signals from the baseband transmitter circuit 1024 as single-ended signals. That is, in such embodiments, only one of the at least two baseband transmitter traces 1026 may be electrically coupled to the baseband transmitter circuit 1024 to receive the outbound intermediate signals, while another one of the at least two baseband transmitter traces 1026 may be electrically coupled to a common ground.

The transmitter module 1016 may further comprise one or more outbound antenna interfaces 1032a-n (hereinafter, the “outbound antenna interfaces 1032”) disposed on the first interposer surface 1008a and configured to be electrically coupled to one or more outbound antennas 1700a-n (hereinafter, the “outbound antennas 1700”) (shown in FIG. 17) and operable to receive the antenna feed signals from the up-conversion circuit 1028 and provide the antenna feed signals to the outbound antennas 1700. It should be understood that, in some embodiments, the transmitter module 1016 may further comprise the outbound antennas 1700 integrated into the transmitter module 1016 itself.

In some embodiments, the transmitter module 1016 may further comprise one or more antenna feed conductive traces 1034a-n (hereinafter, the “antenna feed traces 1034”) disposed on the first interposer surface 1008a. For purposes of clarity, only one of the antenna feed traces 1034 (i.e., antenna feed trace 1034a) is labeled with a reference character. The antenna feed traces 1034 may extend between—and may be electrically coupled to—the up-conversion circuit 1028 and the outbound antenna interfaces 1032. At least two of the antenna feed traces 1034 may be operable to receive the antenna feed signals from the up-conversion circuit 1028, and the outbound antenna interfaces 1032 may be operable to receive the antenna feed signals from the up-conversion circuit 1028 via the at least two antenna feed traces 1034.

It should be understood that, in some embodiments, the at least two antenna feed traces 1034 may be operable to receive the antenna feed signals from up-conversion circuit 1028 as single-ended signals. That is, in such embodiments, only one of the at least two antenna feed traces 1034 may be electrically coupled to the up-conversion circuit 1028 to receive the antenna feed signals, while another one of the at least two antenna feed traces 1034 may be electrically coupled to a common ground.

The receiver module 1018 may comprise one or more inbound antenna interfaces 1036a-n (hereinafter, the “inbound antenna interfaces 1036”) disposed on the first interposer surface 1008a and configured to be electrically coupled to one or more inbound antennas 1704a-n (hereinafter, the “inbound antennas 1704”) (shown in FIG. 17) and operable to receive one or more antenna output signals (hereinafter, the “antenna output signals”) from the inbound antennas 1704, wherein each of the antenna output signals has inbound client data encoded therein and an inbound transmission frequency. The inbound transmission frequency may be in the range between 300 GHz and 10 THz. The outbound antenna(s) 1700 and the inbound antenna(s) may be constructed in a manner shown in FIGS. 9A, 9B, 10, 11, 12, 13, 14, 15, 16, 19, 20, 21, 22A, 22B, 22C, 23, 24A, 24B, 25, 26, 27A, 27B, 27C, 28, 29A, 29B, 29C, 30A, 30B, and 30C and described in the specification of U.S. patent application Ser. No. 18/927,535, filed on Oct. 25, 2024, the content of which is hereby expressly incorporated herein by reference. It should be understood that, in some embodiments, the receiver module 1018 may further comprise the inbound antennas 1704 integrated into the receiver module 1018 itself.

The receiver module 1018 may further comprise a down-conversion circuit 1040 disposed on the first interposer surface 1008a and operable to receive the antenna output signals from the inbound antenna interfaces 1036 and generate one or more inbound intermediate signals (hereinafter, the “inbound intermediate signals”) based on the antenna output signals, wherein each of the inbound intermediate signals has an inbound intermediate frequency less than the inbound transmission frequency of the corresponding antenna output signal (i.e., the antenna output signal upon which a particular inbound intermediate signal is based).

In some embodiments, the receiver module 1018 may further comprise one or more antenna output conductive traces 1042a-n (hereinafter, the “antenna output traces 1042”) disposed on the first interposer surface 1008a. For purposes of clarity, only one of the antenna output traces 1042 (i.e., antenna output trace 1042a) is labeled with a reference character. The antenna output traces 1042 may extend between—and may be electrically coupled to—the inbound antenna interfaces 1036 and the down-conversion circuit 1040. At least two of the antenna output traces 1042 may be operable to receive the antenna output signals from the inbound antenna interfaces 1036, and the down-conversion circuit 1040 may be operable to receive the antenna output signals from the inbound antenna interfaces 1036 via the at least two antenna output traces 1042.

It should be understood that, in some embodiments, the at least two antenna output traces 1042 may be operable to receive the antenna output signals from inbound antenna interfaces 1036 as single-ended signals. That is, in such embodiments, only one of the at least two antenna output traces 1042 may be electrically coupled to the inbound antenna interfaces 1036 to receive the antenna output signals, while another one of the at least two antenna output traces 1042 may be electrically coupled to a common ground.

The receiver module 1018 may further comprise a baseband receiver circuit 1044 disposed on the first interposer surface 1008a and operable to receive the inbound intermediate signals from the down-conversion circuit 1040 and generate one or more inbound baseband signals (hereinafter, the “inbound baseband signals”) based on the inbound intermediate signals, wherein each of the inbound baseband signals has an inbound baseband frequency less than the inbound intermediate frequency of the corresponding inbound intermediate signal (i.e., the inbound intermediate signal upon which a particular inbound baseband signal is based).

In some embodiments, the receiver module 1018 may further comprise one or more baseband receiver conductive traces 1046a-n (hereinafter, the “baseband receiver traces 1046”) disposed on the first interposer surface 1008a. For purposes of clarity, only one of the baseband receiver traces 1046 (i.e., baseband receiver trace 1046a) is labeled with a reference character. The baseband receiver traces 1046 may extend between—and may be electrically coupled to—the down-conversion circuit 1040 and the baseband receiver circuit 1044. At least two of the baseband receiver traces 1046 may be operable to receive the inbound intermediate signals from the down-conversion circuit 1040, and the baseband receiver circuit 1044 may be operable to receive the inbound intermediate signals from the down-conversion circuit 1040 via the at least two baseband receiver traces 1046.

It should be understood that, in some embodiments, the at least two baseband receiver traces 1046 may be operable to receive the inbound intermediate signals from the down-conversion circuit 1040 as single-ended signals. That is, in such embodiments, only one of the at least two baseband receiver traces 1046 may be electrically coupled to the down-conversion circuit 1040 to receive the inbound intermediate signals, while another one of the at least two baseband receiver traces 1046 may be electrically coupled to a common ground.

The receiver module 1018 may further comprise a client-side output 1048 comprising a plurality of output conductive traces 1052a-n (hereinafter, the “output traces 1052”). For purposes of clarity, only one of the output traces 1052 (i.e., output trace 1052a) is labeled with a reference character. At least two of the output traces 1052 may be operable to receive the inbound baseband signals from the baseband receiver circuit 1044 and transmit the inbound baseband signals to a remote destination.

It should be understood that, in some embodiments, the at least two output traces 1052 may be operable to receive the inbound baseband signals from the baseband receiver circuit 1044 as single-ended signals. That is, in such embodiments, only one of the at least two output traces 1052 may be electrically coupled to the baseband receiver circuit 1044 to receive the inbound baseband signals, while another one of the at least two output traces 1052 may be electrically coupled to a common ground.

In the embodiment shown in FIG. 10, the interposer substrate 1004 is implemented using silicon (Si) complementary metal-oxide semiconductor (CMOS) technology, the baseband transmitter circuit 1024 and the baseband receiver circuit 1044 are implemented using Si germanium (SiGe) bipolar CMOS (BiCMOS) technology, and the up-conversion circuit 1028 and the down-conversion circuit are implemented using Si germanium (SiGe) semiconductor technology. However, in other embodiments, one or more of the interposer substrate 1004, the baseband transmitter circuit 1024, the baseband receiver circuit 1044, the up-conversion circuit 1028, and the down-conversion circuit 1040 may be implemented using one or more of CMOS technology, BiCMOS technology, Si semiconductor technology, bipolar Si semiconductor technology, SiGe semiconductor technology, bipolar SiGe semiconductor technology, indium phosphide (InP) semiconductor technology, bipolar InP semiconductor technology, gallium arsenide (GaAs) semiconductor technology, and gallium nitride (GaN) semiconductor technology.

In some embodiments, the client-side input 1020 and the client-side output 1048 may be operable to receive and transmit signals with a bandwidth in a range between 1.2 Terabits (Tb) per second (Tbps) per millimeter (mm) and 1.6 Tbps per mm at 200 Gigabits (Gb) per second (Gbps) per lane. However, in other embodiments, the client-side input 1020 and the client-side output 1048 may be operable to receive and transmit signals with a bandwidth in a range between 224 Gbps per lane and 896 Gbps per lane, such as 448 Gbps per lane, for example.

In some embodiments, the outbound client data and the inbound client data may be encoded in each of the outbound baseband signals and each of the inbound baseband signals, respectively, using an encoding protocol conforming to a specification of one of non-return-to-zero (NRZ) code, phase-amplitude modulation with two levels (PAM2), pulse-amplitude modulation with three levels (PAM3), and phase-amplitude modulation with four levels (PAM4).

Referring now to FIG. 11, in some embodiments, the interposer substrate 1004 may be disposed on a carrier substrate 1100 having a first carrier surface 1104a and a second carrier surface 1104b. The carrier substrate 1100 may further comprise a plurality of carrier conductive pads 1108a-n (hereinafter, the “carrier pads 1108”) disposed on the first carrier surface 1104a, such as a first carrier pad 1108a and a second carrier pad 1108b shown in FIG. 11. Further, in some embodiments, the input traces 1022 of the client-side input 1020 and the output traces 1052 of the client-side output 1048 may be disposed on the first carrier surface 1104a.

As shown in FIG. 11, in some embodiments, the second interposer surface 1008b may abut the first carrier surface 1104a. As a result, at least two of the carrier pads 1108 may be aligned with and electrically coupled to the at least two input traces 1022 such that the at least two carrier pads 1108 may be operable to receive the outbound baseband signals from the at least two input traces 1022. Further, at least two of the TSVs 1014 may be aligned with and electrically coupled to the at least two carrier pads 1088 such that the baseband transmitter circuit 1024 may be operable to receive the outbound baseband signals from the at least two carrier pads 1108 via the at least two TSVs 1014.

It should be understood that, in some embodiments, the at least two carrier pads 1108 may be operable to receive the outbound baseband signals from the at least two input traces 1022 as single-ended signals. That is, in such embodiments, only one of the at least two carrier pads 1108 may be electrically coupled to the at least two input traces 1022 to receive the outbound baseband signals, while another one of the at least two carrier pads 1108 may be electrically coupled to a common ground. Similarly, in such embodiments, the at least two TSVs 1014 may be operable to receive the outbound baseband signals as single-ended signals. That is, in such embodiments, only one of the at least two TSVs 1014 may be electrically coupled to the at last two carrier pads 1108 to receive the outbound baseband signals, while another one of the at least two TSVs 1014 may be electrically coupled to the common ground.

At least two others of the carrier pads 1108 may be configured to be aligned with and electrically coupled to the at least two output traces 1052 such that the at least two output traces 1052 may be operable to receive the inbound baseband signals from the at least two other carrier pads 1108. Further, at least two others of the TSVs 1014 may be configured to be aligned with and electrically coupled to the at least two other carrier pads 1108 such that the at least two output traces 1052 may be operable to receive the inbound baseband signals from the baseband receiver circuit 1044 via the at least two other TSVs 1014.

It should be understood that, in some embodiments, the at least two output traces 1052 may be operable to receive the inbound baseband signals from the at least two other carrier pads 1108 as single-ended signals. That is, in such embodiments, only one of the at least two output traces 1052 may be electrically coupled to the at least two other carrier pads 1108 to receive the inbound baseband signals, while another one of the at least two output traces 1052 may be electrically coupled to the common ground. Similarly, in such embodiments, the at least two other TSVs 1014 may be operable to receive the inbound baseband signals from the baseband receiver circuit 1044 as single-ended signals. That is, in such embodiments, only one of the at least two other TSVs 1014 may be electrically coupled to the baseband receiver circuit 1044 to receive the inbound baseband signals, while another one of the at least two other TSVs 1014 may be electrically coupled to a common ground.

In some embodiments, each of the carrier pads 1108 may have a diameter in a range between 5 micrometers (μm) and 100 μm. In some embodiments, each of the carrier pads 1108 may be implemented as one of a copper (Cu) pillar, a solder bump constructed using one or more of tin (Sn), silver (Ag), and gold (Au), for example, and a direct bond interconnect (DBI).

The transceiver 1000 may comprise a transceiver module 1112 wherein the up-conversion circuit 1028 of the transmitter module 1016 shown in FIG. 10 and the down-conversion circuit 1040 of the receiver module 1018 shown in FIG. 10 are integrated into a single semiconductor die to form a conversion circuit 1116. The conversion circuit 1116 may be operable to, in a first direction, receive the outbound intermediate signals from the baseband transmitter circuit 1024 and generate the antenna feed signals based on the outbound intermediate signals, and in a second direction, receive the antenna output signals from the inbound antenna interfaces 1036 and generate the inbound intermediate signals based on the antenna output signals.

In some embodiments, at least one of the thermal vias 1012 may be disposed between the conversion circuit 1116 and the carrier substrate 1100 and is operable to conduct heat away from the conversion circuit 1116 and toward the carrier substrate 1100.

In the embodiment shown in FIG. 11, the interposer substrate 1004 is implemented using Si CMOS technology, the baseband transmitter circuit 1024 and the baseband receiver circuit 1044 are implemented using CMOS technology, and the conversion circuit 1116 is implemented using SiGe BiCMOS technology. However, as referenced above, the interposer substrate 1004, the baseband transmitter circuit 1024, the baseband receiver circuit 1044, and the conversion circuit 1116 may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

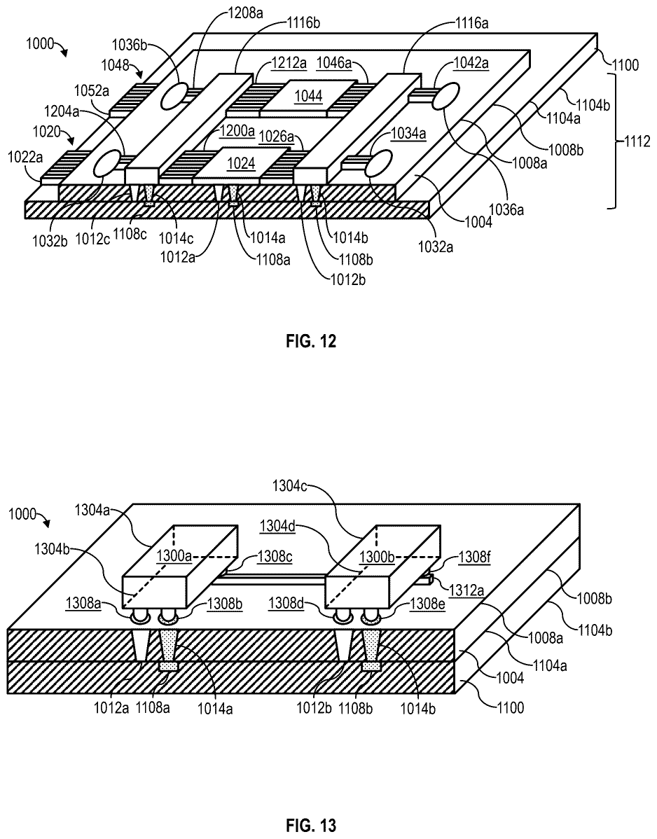

Referring now to FIG. 12, in some embodiments, the transceiver module 1112 may comprise a plurality of the outbound antenna interfaces 1032, such as a first outbound antenna interface 1032a and a second outbound antenna interface 1032b, and a plurality of the inbound antenna interfaces 1036, such as a first inbound antenna interface 1036a and a second inbound antenna interface 1036b. Accordingly, the interposer substrate 1004 may further define a third thermal via 1012c in the interposer substrate 1004 in addition to the first thermal via 1012a and the second thermal via 1012b and a third TSV 1014c in addition to the first TSV 1014a and the second TSV 1014b. Further, the carrier substrate 1100 may comprise a third carrier pad 1108c in addition to the first carrier pad 1108a and the second carrier pad 1108b, and the transceiver module 1112 may comprise a plurality of the conversion circuits 1116, such as a first conversion circuit 1116a and a second conversion circuit 1116b.

In some embodiments, the baseband transmitter traces 1026 are first baseband transmitter traces 1026, the antenna feed traces 1034 are first antenna feed traces 1034, the antenna output traces 1042 are first antenna output traces 1042, and the baseband receiver traces 1046 are first baseband receiver traces 1046, and the transceiver module 1112 may further comprise one or more second baseband transmitter traces 1200a-n (hereinafter, the “second baseband transmitter traces 1200”), one or more second antenna feed traces 1204a-n (hereinafter, the “second antenna feed traces 1204”), one or more second antenna output traces 1208a-n (hereinafter, the “second antenna output traces 1208”), and one or more second baseband receiver traces 1212a-n (hereinafter, the “second baseband receiver traces 1212”). For purposes of clarity, only one of the second baseband transmitter traces 1200 (i.e., second baseband transmitter trace 1200a), the second antenna feed traces 1204 (i.e., second antenna feed trace 1204a), the second antenna output traces 1208 (i.e., second antenna output trace 1208a), and the second baseband receiver traces 1212 (i.e., second baseband receiver trace 1212a) are labeled with a reference character.

In the embodiment shown in FIG. 12, the interposer substrate 1004 is implemented using Si CMOS technology, the baseband transmitter circuit 1024 and the baseband receiver circuit 1044 are implemented using SiGe BiCMOS technology, and the first conversion circuit 1116a and the second conversion circuit 1116b are implemented using SiGe semiconductor technology. However, as referenced above, the interposer substrate 1004, the baseband transmitter circuit 1024, the baseband receiver circuit 1044, the first conversion circuit 1116a, and the second conversion circuit 1116b may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

Referring now to FIG. 13, shown therein is an exemplary embodiment of a first semiconductor die 1300a and a second semiconductor die 1300b (collectively, the “semiconductor dies 1300”) constructed in accordance with the present disclosure, wherein the semiconductor dies 1300 are disposed on the first interposer surface 1008a of the interposer substrate 1004 and the second interposer surface 1008b abuts the first carrier surface 1104a of the carrier substrate 1100. The arrangement of the semiconductor dies 1300 disposed on the interposer substrate 1004 provided with one or more vias (i.e., the thermal vias 1012 and the TSVs 1014) and one or more conductive traces 1312a-n (hereinafter, the “traces 1312”) (i.e., a first trace 1312a shown in FIG. 13) for communicating signals to and from the semiconductor dies 1300 may be referred to herein as a “flip chip” arrangement.

The first semiconductor die 1300a may have a first die surface 1304a and a second die surface 1304b opposite the first die surface 1304a, while the second semiconductor die 1300b may have a third die surface 1304c and a fourth die surface 1304d opposite the third die surface 1304c, wherein the second die surface 1304b of the first semiconductor die 1300a and the fourth die surface 1304d of the second semiconductor die 1300b may abut the first interposer surface 1008a of the interposer substrate 1004. Further, the semiconductor dies 1300 may have a plurality of die conductive pads 1308a-n (hereinafter, the “die pads 1308”) disposed on the second die surface 1304b of the first semiconductor die 1300a and the fourth die surface 1304d of the second semiconductor die 1300b. In the embodiment shown in FIG. 13, the first semiconductor die 1300a has a first die pad 1308a, a second die pad 1308b, and a third die pad 1308c disposed on the second die surface 1304b, while the second semiconductor die 1300b has a fourth die pad 1308d, a fifth die pad 1308e, and a sixth die pad 1308f disposed on the fourth die surface 1304d, wherein at least one of the die pads 1308 of each of the semiconductor dies 1300 (e.g., the first die pad 1308a and the fourth die pad 1308d) is aligned with and electrically coupled to at least one of the thermal vias 1012 (e.g., the first thermal via 1012a and the second thermal via 1012b, respectively), at least one other of the die pads 1308 of each of the semiconductor dies 1300 (e.g., the second die pad 1308b and the fifth die pad 1308e) is aligned with and electrically coupled to at least one of the TSVs 1014 (e.g., the first TSV 1014a and the second TSV 1014b, respectively), and at least one other of the die pads of each of the semiconductor dies 1300 (e.g., the third die pad 1308c and the sixth die pad 1308f), and at least one other of the die pads 1308 of each of the semiconductor dies 1300 (e.g., the third die pad 1308c and the sixth die pad 1308f) may be aligned with and electrically coupled to at least one of the traces 1312 (e.g., the first trace 1312a).

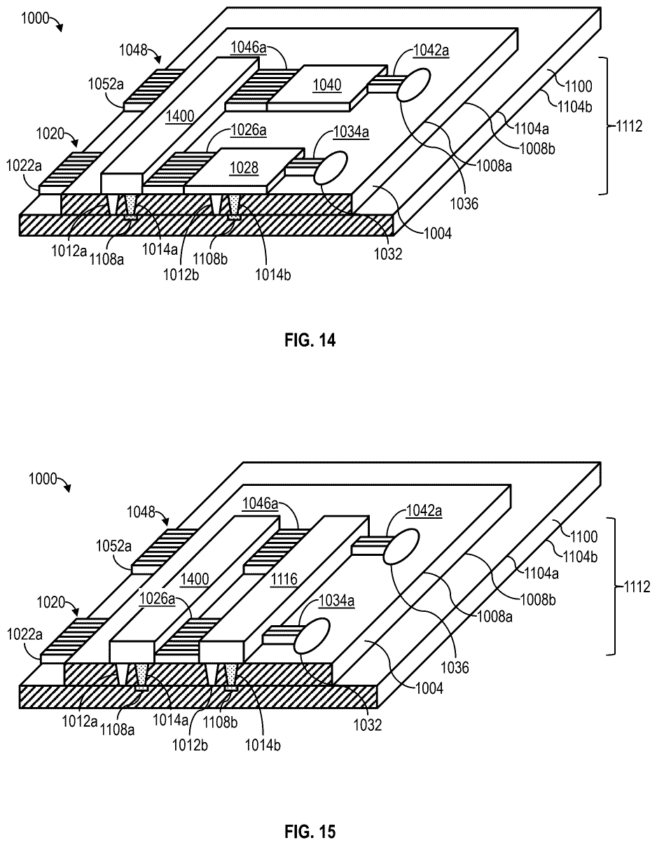

It should be understood that one or more of the baseband transmitter circuit 1024, the baseband receiver circuit 1044, the baseband transceiver circuit 1400 (shown in FIG. 14), the up-conversion circuit 1028, the down-conversion circuit 1040, and the conversion circuit 1116 may be implemented as separate embodiments of the semiconductor dies 1300 as described herein. Further, two or more of the baseband transmitter circuit 1024, the baseband receiver circuit 1044, the baseband transceiver circuit 1400, the up-conversion circuit 1028, the down-conversion circuit 1040, and the conversion circuit 1116 may be integrated into a single embodiment of the semiconductor dies 1300 as described herein.

It should be further understood that one or more of the input traces 1022, the baseband transmitter traces 1026, the antenna feed traces 1034, the antenna output traces 1042, the baseband receiver traces 1046, and the output traces 1052 may be implemented as separate embodiments of the traces 1312 as described herein.

In some embodiments, each of the die pads 1308 may have a diameter in the range between 5 μm and 100 μm. In some embodiments, each of the die pads 1308 may be implemented as one of a Cu pillar, a solder bump comprising one or more of tin (Sn), silver (Ag), and gold (Au), for example, and a DBI.

In the embodiment shown in FIG. 13, the interposer substrate 1004 is implemented using Si semiconductor technology, and the semiconductor dies 1300 are implemented using SiGe semiconductor technology. However, as referenced above, the interposer substrate 1004 and the semiconductor dies 1300 may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

Referring now to FIG. 14, in some embodiments, the transceiver 1000 may comprise the transceiver module 1112 wherein the baseband transmitter circuit 1024 shown in FIG. 10 and the baseband receiver circuit 1044 shown in FIG. 10 are integrated into a single semiconductor die to form a baseband transceiver circuit 1400. The baseband transceiver circuit 1400 may be operable to, in a first direction, receive the outbound baseband signals from the client-side input 1020 and generate the outbound intermediate signals based on the outbound baseband signals, and in a second direction, receive the inbound intermediate signals from the down-conversion circuit 1040 and generate the inbound baseband signals based on the inbound intermediate signals.

In the embodiment shown in FIG. 14, the interposer substrate 1004 is implemented using SiGe semiconductor technology, the baseband transceiver circuit 1400 is implemented using Si CMOS technology, and the up-conversion circuit 1028 and the down-conversion circuit 1040 are implemented using SiGe semiconductor technology. However, as referenced above, the interposer substrate 1004, the baseband transceiver circuit 1400, the up-conversion circuit 1028, and the down-conversion circuit 1040 may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

Referring now to FIG. 15, in some embodiments, transceiver 1000 may comprise the transceiver module 1112 wherein the up-conversion circuit 1028 of the transmitter module 1016 and the down-conversion circuit 1040 of the receiver module 1018 are integrated into a single semiconductor die to form the conversion circuit 1116, and the baseband transmitter circuit 1024 and the baseband receiver circuit 1044 are integrated into a single semiconductor die to form the baseband transceiver circuit 1400. The baseband transceiver circuit 1400 may be operable to, in a first direction, receive the outbound baseband signals from the client-side input 1020 and generate the outbound intermediate signals based on the outbound baseband signals, and in a second direction, receive the inbound intermediate signals from the conversion circuit 1116 and generate the inbound baseband signals based on the inbound intermediate signals. The conversion circuit 1116 may be operable to, in a first direction, receive the outbound intermediate signals from the baseband transceiver circuit 1400 and generate the antenna feed signals based on the outbound intermediate signals, and in a second direction, receive the antenna output signals from the inbound antenna interfaces 1036 and generate the inbound intermediate signals based on the antenna output signals.

In the embodiment shown in FIG. 15, the interposer substrate 1004 is implemented as a passive substrate, the baseband transceiver circuit 1400 is implemented using Si CMOS technology, and the conversion circuit 1116 is implemented using SiGe semiconductor technology. However, as referenced above, the interposer substrate 1004, the baseband transceiver circuit 1400, and the conversion circuit 1116 may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

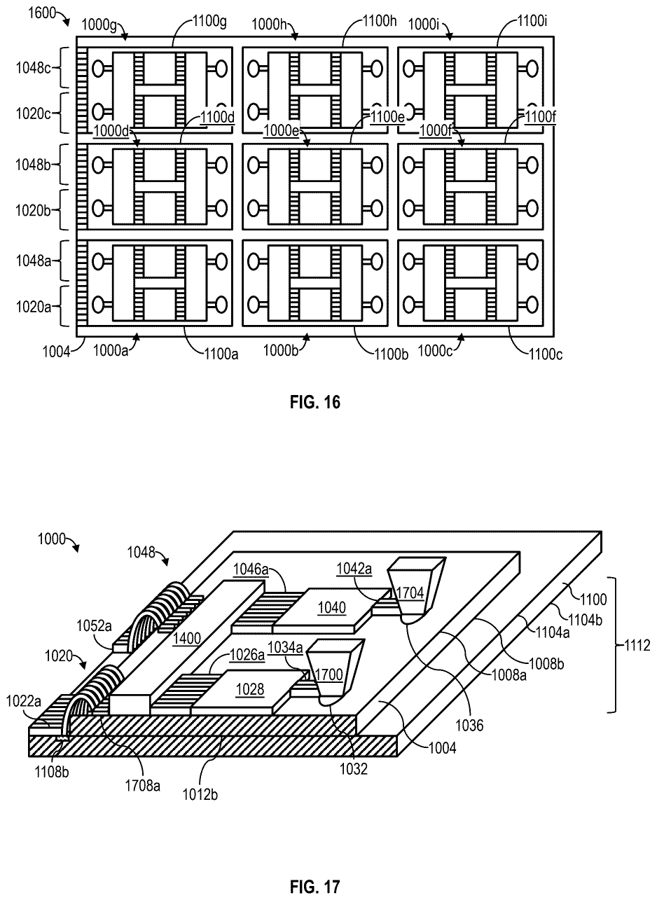

Referring now to FIG. 16, shown therein is an exemplary embodiment of a transceiver array 1600 constructed in accordance with the present disclosure. The transceiver array 1600 may comprise the interposer substrate 1004, a plurality of client-side inputs 1020a-n (hereinafter, the “client-side inputs 1020”) such as a first client-side input 1020a, a second client-side input 1020b, and a third client-side input 1020c, a plurality of client-side outputs 1048a-n (hereinafter, the “client-side outputs 1048”) such as a first client-side output 1048a, a second client-side output 1048b, and a third client-side output 1048c, a plurality of transceivers 1000a-n (hereinafter, the “transceivers 1000”) such as a first transceiver 1000a, a second transceiver 1000b, a third transceiver 1000c, a fourth transceiver 1000d, a fifth transceiver 1000e, a sixth transceiver 1000f, a seventh transceiver 1000g, an eighth transceiver 1000h, and a ninth transceiver 1000i, wherein each of the transceivers 1000 is disposed on one of a plurality of carrier substrates 1100a-n (hereinafter, the “carrier substrates 1100”), such as a first carrier substrate 1100a, a second carrier substrate 1100b, a third carrier substrate 1100c, a fourth carrier substrate 1100d, a fifth carrier substrate 1100e, a sixth carrier substrate 1100f, a seventh carrier substrate 1100g, an eighth carrier substrate 1100h, and a ninth carrier substrate 1100i.

In some embodiments, the first client-side input 1020a may provide first outbound baseband signals to the first transceiver 1000a, the second transceiver 1000b, and the third transceiver 1000c, while the first client-side output 1048a may receive first inbound baseband signals from the first transceiver 1000a, the second transceiver 1000b, and the third transceiver 1000c. Similarly, the second client-side input 1020b may provide second outbound baseband signals to the fourth transceiver 1000d, the fifth transceiver 1000e, and the sixth transceiver 1000f, while the second client-side output 1048b may receive second inbound baseband signals from the fourth transceiver 1000d, the fifth transceiver 1000e, and the sixth transceiver 1000f. Finally, the third client-side input 1020c may provide third outbound baseband signals to the seventh transceiver 1000g, the eighth transceiver 1000h, and the ninth transceiver 1000i, while the third client-side output 1048c may receive third inbound baseband signals from the seventh transceiver 1000g, the eighth transceiver 1000h, and the ninth transceiver 1000i.

Referring now to FIG. 17, in some embodiments, the transceiver 1000 may further comprise one or more outbound antennas 1700a-n (hereinafter, the “outbound antennas 1700”) configured to be electrically coupled to the outbound antenna interface 1032 and one or more inbound antennas 1704a-n (hereinafter, the “inbound antennas 1704”) configured to be electrically coupled to the inbound antenna interface 1036. As referenced above, it should be understood that the description referring to any particular one of the antennas 416, 516, 616, 900, 1700, 1704 may refer to any of the antennas 416, 516, 616, 900, 1700, 1704 described herein.

Each of the outbound antennas 1700 may be operable to receive the antenna feed signals from the outbound antenna interface 1032, generate one or more outbound radiated signals (hereinafter, the “outbound radiated signals”) based on the antenna feed signals, and couple the outbound radiated signals into one or more hollow waveguides 208 (hereinafter, the “hollow waveguides 208”). Similarly, each of the inbound antennas 1704 may be operable to detect one or more inbound radiated signals (hereinafter, the “inbound radiated signals”) coupled into the hollow waveguides 208 (i.e., the same hollow waveguides 208 into which the outbound radiated signals are coupled or different hollow waveguides 208) and generate the antenna output signals based on the inbound radiated signals.

In some embodiments, the transceiver 1000 may lack the vias disposed beneath the baseband transceiver circuit 1400 (or the baseband transmitter circuit 1024 and the baseband receiver circuit 1044 in other embodiments). In such embodiments, the transceiver 1000 further comprise a plurality of wire bond connections 1708a-n (hereinafter, the “wire bond baseband connections 1708”) extending between the carrier pads 1108 of the carrier substrate 1100 coupled to the input traces 1022 of the client-side input 1020 and the baseband transceiver circuit 1400 (or the baseband transmitter circuit 1024 in other embodiments), thereby electrically coupling each of the input traces 1022 of the client-side input 1020 to the baseband transceiver circuit 1400 (or the baseband transmitter circuit 1024 in other embodiments) via the wire bond baseband connections 1708 and between the carrier pads 1108 of the carrier substrate 1100 coupled to the output traces 1052 of the client-side output 1048 and the baseband transceiver circuit 1400 (or the baseband receiver circuit 1044 in other embodiments), thereby electrically coupling each of the output traces 1052 of the client-side output 1048 to the baseband transceiver circuit 1400 (or the baseband receiver circuit 1044 in other embodiments) via the wire bond baseband connections 1708. For purposes of clarity, only one of the wire bond baseband connections 1708 (i.e., wire bond baseband connection 1708a) is labeled with a reference character.

In the embodiment shown in FIG. 17, the interposer substrate 1004 is implemented using SiGe semiconductor technology, the baseband transceiver circuit 1400 is implemented using Si CMOS technology, and the up-conversion circuit 1028 and the down-conversion circuit 1040 are implemented using SiGe semiconductor technology. However, as referenced above, the interposer substrate 1004, the baseband transceiver circuit 1400, the up-conversion circuit 1028, and the down-conversion circuit 1040 may be implemented using one or more of CMOS technology, BiCMOS technology, Si semiconductor technology, bipolar Si semiconductor technology, SiGe semiconductor technology, bipolar SiGe semiconductor technology, InP semiconductor technology, bipolar InP semiconductor technology, GaAs semiconductor technology, and GaN semiconductor technology.

### ILLUSTRATIVE CLAUSES

Exemplary, non-limiting illustrative clauses are provided in the clauses below. However, the scope of the present inventive concept(s) is to be understood to not be limited in any manner by the clauses presented below.

Illustrative clause 1. A transmitter, comprising: a carrier substrate having a carrier surface and comprising a plurality of first conductive pads disposed on the carrier surface; a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to the at least two first conductive pads; a baseband transmitter circuit disposed on the first interposer surface and operable to receive the one or more baseband signals from the at least two first conductive pads via the at least two vias and generate one or more intermediate signals based on the one or more baseband signals, each of the one or more intermediate signals having an intermediate frequency greater than the baseband frequency of a corresponding one of the one or more baseband signals; an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

Illustrative clause 2. The transmitter of illustrative clause 1, wherein each of the plurality of first conductive pads and the plurality of second conductive pads has a diameter in a range between 5 micrometers (μm) and 100 μm.

Illustrative clause 3. The transmitter of illustrative clause 1, wherein each of the plurality of first conductive pads and the plurality of second conductive pads is one of a copper (Cu) pillar, a solder bump constructed using one or more of tin (Sn), silver (Ag), and gold (Au), and a direct bond interconnect (DBI).

Illustrative clause 4. The transmitter of illustrative clause 1, wherein each of the interposer substrate and the up-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

Illustrative clause 5. The transmitter of illustrative clause 1, wherein the baseband transmitter circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

Illustrative clause 6. The transmitter of illustrative clause 1, wherein the client data is encoded in each of the one or more baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

Illustrative clause 7. The transmitter of illustrative clause 1, further comprising one or more antennas electrically coupled to the one or more antenna interfaces and operable to receive the one or more antenna feed signals from the one or more antenna interfaces, generate one or more radiated signals based on the one or more antenna feed signals, and couple the one or more radiated signals into a hollow waveguide, each of the one or more radiated signals being radiated electromagnetic waves and having the transmission frequency.

Illustrative clause 8. The transmitter of illustrative clause 1, wherein the plurality of vias includes: a plurality of through-silicon vias (TSVs) configured to route signals between the first interposer surface and the second interposer surface, at least two TSVs of the plurality of TSVs being aligned with and electrically coupled to the at least two second conductive pads, the baseband transmitter circuit being operable to receive the one or more baseband signals from the at least two second conductive pads via the at least two TSVs; and one or more thermal vias configured to conduct heat away from the first interposer surface and toward the second interposer surface.

Illustrative clause 9. The transmitter of illustrative clause 8, wherein at least one thermal via of the one or more thermal vias is disposed between the up-conversion circuit and the carrier substrate and is further operable to conduct heat away from the up-conversion circuit and toward the carrier substrate.

Illustrative clause 10. A receiver, comprising: a carrier substrate having a carrier surface and comprising a plurality of first conductive pads disposed on the carrier surface; an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to at least two first conductive pads of the plurality of first conductive pads; a baseband receiver circuit disposed on the first interposer surface; one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz); a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals; wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals; wherein the at least two first conductive pads are operable to receive the one or more baseband signals from the baseband receiver circuit via the at least two vias; and a client-side output comprising a plurality of conductive traces disposed on the carrier surface, at least two conductive traces of the plurality of conductive traces being operable to receive the one or more baseband signals from the at least two first conductive pads and transmit the one or more baseband signals.

Illustrative clause 11. The receiver of illustrative clause 10, wherein each of the plurality of first conductive pads and the plurality of second conductive pads has a diameter in a range between 5 micrometers (μm) and 100 μm.

Illustrative clause 12. The receiver of illustrative clause 10, wherein each of the plurality of first conductive pads and the plurality of second conductive pads is one of a copper (Cu) pillar, a solder bump constructed using one or more of tin (Sn), silver (Ag), and gold (Au), and a direct bond interconnect (DBI).

Illustrative clause 13. The receiver of illustrative clause 10, wherein each of the interposer substrate and the down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

Illustrative clause 14. The receiver of illustrative clause 10, wherein the baseband receiver circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

Illustrative clause 15. The receiver of illustrative clause 10, wherein the client data is encoded in each of the one or more baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

Illustrative clause 16. The receiver of illustrative clause 10, further comprising one or more antennas electrically coupled to the one or more antenna interfaces and operable to detect one or more radiated signals coupled into a hollow waveguide and generate the one or more antenna output signals based on the one or more radiated signals, each of the one or more radiated signals being radiated electromagnetic waves and having the transmission frequency.

Illustrative clause 17. The receiver of illustrative clause 10, wherein the plurality of vias include: a plurality of through-silicon vias (TSVs) configured to route signals between the first interposer surface and the second interposer surface, at least two TSVs of the plurality of TSVs being aligned with and electrically coupled to the at least two first conductive pads, the at least two first conductive pads being operable to receive the one or more baseband signals from the baseband receiver circuit via the at least two TSVs; and one or more thermal vias configured to conduct heat away from the first interposer surface and toward the second interposer surface.

Illustrative clause 18. The receiver of illustrative clause 17, wherein at least one thermal via of the one or more thermal vias is disposed between the down-conversion circuit and the carrier substrate and is further operable to conduct heat away from the down-conversion circuit and toward the carrier substrate.

Illustrative clause 19. A transceiver, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to at least two first inbound conductive pads of the plurality of first inbound conductive pads; a baseband transmitter circuit disposed on the first interposer surface and operable to receive the one or more outbound baseband signals from the at least two first outbound conductive pads via the at least two first vias and generate one or more outbound intermediate signals based on the one or more outbound baseband signals, each of the one or more outbound intermediate signals having an outbound intermediate frequency greater than the outbound baseband frequency of a corresponding one of the one or more outbound baseband signals; a baseband receiver circuit disposed on the first interposer surface; an up-conversion circuit having an up-conversion surface and comprising a plurality of second outbound conductive pads disposed on the up-conversion surface, the up-conversion surface abutting the first interposer surface such that at least two second outbound conductive pads of the plurality of second outbound conductive pads are electrically coupled to the baseband transmitter circuit, the up-conversion circuit being operable to receive the one or more outbound intermediate signals from the baseband transmitter circuit via the at least two second outbound conductive pads and generate one or more antenna feed signals based on the one or more outbound intermediate signals, each of the one or more antenna feed signals having an outbound transmission frequency greater than the outbound intermediate frequency of a corresponding one of the one or more outbound intermediate signals and in a range between 300 Gigahertz (GHz) and 10 Terahertz (THz); one or more outbound antenna interfaces disposed on the first interposer surface, each of the one or more outbound antenna interfaces being configured to be electrically coupled to one or more outbound antennas and operable to receive the one or more antenna feed signals from the up-conversion circuit and provide the one or more antenna feed signals to the one or more outbound antennas; one or more inbound antenna interfaces disposed on the first interposer surface, each of the one or more inbound antenna interfaces being configured to be electrically coupled to one or more inbound antennas and operable to receive one or more antenna output signals from the one or more inbound antennas, each of the one or more antenna output signals having inbound client data encoded therein and an inbound transmission frequency in a range between 300 GHz and 10 THz; a down-conversion circuit having a down-conversion surface and comprising a plurality of second inbound conductive pads disposed on the down-conversion surface, the down-conversion surface abutting the first interposer surface such that at least two second inbound conductive pads of the plurality of second inbound conductive pads are electrically coupled to the baseband receiver circuit, the down-conversion circuit being operable to receive the one or more antenna output signals from the one or more inbound antenna interfaces and generate one or more inbound intermediate signals based on the one or more antenna output signals, each of the one or more inbound intermediate signals having an inbound intermediate frequency less than the inbound transmission frequency of a corresponding one of the one or more antenna output signals; wherein the baseband receiver circuit is operable to receive the one or more inbound intermediate signals from the down-conversion circuit via the at least two second inbound conductive pads and generate one or more inbound baseband signals based on the one or more inbound intermediate signals, each of the one or more inbound baseband signals having an inbound baseband frequency less than the inbound intermediate frequency of a corresponding one of the one or more inbound intermediate signals; wherein the at least two first inbound conductive pads of the plurality of first inbound conductive pads are operable to receive the one or more inbound baseband signals from the baseband receiver circuit via the at least two second vias; and a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

Illustrative clause 20. The transceiver of illustrative clause 19, wherein each of the plurality of first outbound conductive pads, the plurality of second outbound conductive pads, the plurality of first inbound conductive pads, and the plurality of second inbound conductive pads has a diameter in a range between 5 micrometers (μm) and 100 μm.

Illustrative clause 21. The transceiver of illustrative clause 19, wherein each of the plurality of first outbound conductive pads, the plurality of second outbound conductive pads, the plurality of first inbound conductive pads, and the plurality of second inbound conductive pads is one of a copper (Cu) pillar, a solder bump constructed using one or more of tin (Sn), silver (Ag), and gold (Au), and a direct bond interconnect (DBI).

Illustrative clause 22. The transceiver of illustrative clause 19, wherein each of the interposer substrate, the up-conversion circuit, and the down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

Illustrative clause 23. The transceiver of illustrative clause 21, wherein each of the baseband transmitter circuit and the baseband receiver circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

Illustrative clause 24. The transceiver of illustrative clause 19, wherein the outbound client data is encoded in each of the one or more outbound baseband signals and the inbound client data is encoded in each of the one or more inbound baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

Illustrative clause 25. The transceiver of illustrative clause 19, further comprising: one or more outbound antennas electrically coupled to the one or more outbound antenna interfaces and operable to receive the one or more antenna feed signals from the one or more outbound antenna interfaces, generate one or more outbound radiated signals based on the one or more antenna feed signals, and couple the one or more outbound radiated signals into a first hollow waveguide, each of the one or more outbound radiated signals being radiated electromagnetic waves and having the outbound transmission frequency; and one or more inbound antennas electrically coupled to the one or more inbound antenna interfaces and operable to detect one or more inbound radiated signals coupled into one of the first hollow waveguide and a second hollow waveguide and generate the one or more antenna output signals based on the one or more inbound radiated signals, each of the one or more inbound radiated signals being radiated electromagnetic waves and having the inbound transmission frequency.

Illustrative clause 26. The transceiver of illustrative clause 19, wherein the plurality of vias includes: a plurality of through-silicon vias (TSVs) configured to route signals between the first interposer surface and the second interposer surface, at least two first TSVs of the plurality of TSVs being aligned with and electrically coupled to the at least two first outbound conductive pads, at least two second TSVs of the plurality of TSVs being aligned with and electrically coupled to the at least two first inbound conductive pads, the baseband transmitter circuit being operable to receive the one or more outbound baseband signals from the plurality of first outbound conductive pads via the at least two first TSVs, the at least two first inbound conductive pads being operable to receive the one or more inbound baseband signals from the baseband receiver circuit via the at least two second TSVs; and one or more thermal vias configured to conduct heat away from the first interposer surface and toward the second interposer surface.

Illustrative clause 27. The transceiver of illustrative clause 26, wherein the one or more thermal vias are further defined as a plurality of thermal vias, at least one first thermal via of the plurality of thermal vias being disposed between the up-conversion circuit and the carrier substrate and being further operable to conduct heat away from the up-conversion circuit and toward the carrier substrate and at least one second thermal via of the plurality of thermal vias being disposed between the down-conversion circuit and the carrier substrate and being further operable to conduct heat away from the down-conversion circuit and toward the carrier substrate.

Illustrative clause 28. The transceiver of illustrative clause 19, wherein the baseband transmitter circuit and the baseband receiver circuit are integrated into a single semiconductor die.

Illustrative clause 29. The transceiver of illustrative clause 19, wherein the up-conversion circuit and the down-conversion circuit are integrated into a single semiconductor die.

Illustrative clause 30. The transceiver of illustrative clause 19, wherein the baseband transmitter circuit and the baseband receiver circuit are integrated into a first semiconductor die and the up-conversion circuit and the down-conversion circuit are integrated into a second semiconductor die.

Illustrative clause 31. A transceiver, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of are aligned with and electrically coupled to at least two first inbound conductive pads of the plurality of first inbound conductive pads; a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals; a baseband receiver circuit disposed on the first interposer surface; a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz); one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas; a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz; one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas; one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz; a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals; one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz; a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals; wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals; wherein the at least two first inbound conductive pads are operable to receive the one or more inbound baseband signals from the baseband receiver circuit via the at least two second vias; and a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

Illustrative clause 32. The transceiver of illustrative clause 31, wherein each of the plurality of first outbound conductive pads, the plurality of second outbound conductive pads, the plurality of third outbound conductive pads, the plurality of first inbound conductive pads, the plurality of second inbound conductive pads, and the plurality of third inbound conductive pads has a diameter in a range between 5 micrometers (μm) and 100 μm.

Illustrative clause 33. The transceiver of illustrative clause 31, wherein each of the plurality of first outbound conductive pads, the plurality of second outbound conductive pads, the plurality of third outbound conductive pads, the plurality of first inbound conductive pads, the plurality of second inbound conductive pads, and the plurality of third inbound conductive pads is one of a copper (Cu) pillar, a solder bump constructed using one or more of tin (Sn), silver (Ag), and gold (Au), and a direct bond interconnect (DBI).

Illustrative clause 34. The transceiver of illustrative clause 31, wherein each of the interposer substrate, the first up-conversion circuit, the second up-conversion circuit, the first down-conversion circuit, and the second down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

Illustrative clause 35. The transceiver of illustrative clause 31, wherein each of the baseband transmitter circuit and the baseband receiver circuit are implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

Illustrative clause 36. The transceiver of illustrative clause 31, wherein the outbound client data is encoded in each of the one or more outbound baseband signals and the first inbound client data and the second inbound client data are encoded in each of the one or more inbound baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

Illustrative clause 37. The transceiver of illustrative clause 31, further comprising: one or more first outbound antennas electrically coupled to the one or more first outbound antenna interfaces and operable to receive the one or more first antenna feed signals from the one or more first outbound antenna interfaces, generate one or more first outbound radiated signals based on the one or more first antenna feed signals, and couple the one or more first outbound radiated signals into a first hollow waveguide, each of the one or more first outbound radiated signals being radiated electromagnetic waves and having the first outbound transmission frequency; one or more second outbound antennas electrically coupled to the one or more second outbound antenna interfaces and operable to receive the one or more second antenna feed signals from the one or more second outbound antenna interfaces, generate one or more second outbound radiated signals based on the one or more second antenna feed signals, and couple the one or more second outbound radiated signals into one of the first hollow waveguide and a second hollow waveguide; one or more first inbound antennas electrically coupled to the one or more first inbound antenna interfaces and operable to detect one or more first inbound radiated signals coupled into one of the first hollow waveguide, the second hollow waveguide, and a third hollow waveguide and generate the one or more first antenna output signals based on the one or more first inbound radiated signals, each of the one or more first inbound radiated signals being radiated electromagnetic waves and having the first inbound transmission frequency; and one or more second inbound antennas electrically coupled to the one or more second inbound antenna interfaces and operable to detect one or more second inbound radiated signals coupled into one of the first hollow waveguide, the second hollow waveguide, the third hollow waveguide, and a fourth hollow waveguide and generate the one or more second antenna output signals based on the one or more second inbound radiated signals, each of the one or more second inbound radiated signals being radiated electromagnetic waves and having the second inbound transmission frequency.

Illustrative clause 38. The transceiver of illustrative clause 31, wherein the plurality of vias includes: a plurality of through-silicon vias (TSVs) configured to route signals between the first interposer surface and the second interposer surface, at least two first TSVs of the plurality of TSVs being aligned and electrically coupled to with the at least two first outbound conductive pads, at least two second TSVs of the plurality of TSVs being aligned with and electrically coupled to the at least two first inbound conductive pads, the baseband transmitter circuit being operable to receive the one or more outbound baseband signals from the plurality of first outbound conductive pads via the at least two first TSVs, the at least two first inbound conductive pads being operable to receive the one or more inbound baseband signals from the baseband receiver circuit via the at least two second TSVs; and one or more thermal vias configured to conduct heat away from the first interposer surface and toward the second interposer surface.

Illustrative clause 39. The transceiver of illustrative clause 38, wherein the one or more thermal vias are further defined as a plurality of thermal vias, at least one first thermal via of the plurality of thermal vias being disposed between the first up-conversion circuit and the carrier substrate and being further operable to conduct heat away from the first up-conversion circuit and toward the carrier substrate, at least one second thermal via of the plurality of thermal vias being disposed between the second up-conversion circuit and the carrier substrate and being further operable to conduct heat away from the second up-conversion circuit and toward the carrier substrate, at least one third thermal via of the plurality of thermal vias being disposed between the first down-conversion circuit and the carrier substrate and being further operable to conduct heat away from the first down-conversion circuit and toward the carrier substrate, at least one fourth thermal via of the plurality of thermal vias being disposed between the second down-conversion circuit and the carrier substrate and being further operable to conduct heat away from the second down-conversion circuit and toward the carrier substrate.

Illustrative clause 40. The transceiver of illustrative clause 31, wherein the baseband transmitter circuit and the baseband receiver circuit are integrated into a single semiconductor die.

Illustrative clause 41. The transceiver of illustrative clause 31, wherein the first up-conversion circuit and the first down-conversion circuit are integrated into a first semiconductor die and the second up-conversion circuit and the second down-conversion circuit are integrated into a second semiconductor die.

Illustrative clause 42. The transceiver of illustrative clause 31, wherein the baseband transmitter circuit and the baseband receiver circuit are integrated into a first semiconductor die, the first up-conversion circuit and the first down-conversion circuit are integrated into a second semiconductor die, and the second up-conversion circuit and the second down-conversion circuit are integrated into a third semiconductor die.

Illustrative clause 43. A transceiver array, comprising: a carrier substrate having a carrier surface and comprising a plurality of first outbound conductive pads and a plurality of first inbound conductive pads disposed on the carrier surface; a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency; a client-side output comprising a plurality of second conductive traces disposed on the carrier surface, at least two second conductive traces of the plurality of second conductive traces being operable to receive one or more inbound baseband signals from at least two first inbound conductive pads of the plurality of first inbound conductive pads and transmit the one or more inbound baseband signals; and a plurality of transceivers, each of the plurality of transceivers comprising: an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to the at least two first inbound conductive pads; a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals; a baseband receiver circuit disposed on the first interposer surface; a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz); one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas; a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz; one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas; one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz; a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals; one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz; a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals; wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate the one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals; and wherein the at least two first inbound conductive pads are operable to receive the one or more inbound baseband signals from the baseband receiver circuit via the at least two second vias.

Illustrative clause 44. A transmitter, comprising: a carrier substrate having a carrier surface and comprising a plurality of first conductive pads disposed on the carrier surface; a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency; an interposer substrate having a first interposer surface and a second interposer surface opposite the first interposer surface, the second interposer surface abutting the carrier surface; a baseband transmitter circuit disposed on the first interposer surface and operable to receive the one or more baseband signals from the at least two first conductive pads via two or more wire bond connections extending between the at least two first conductive pads and the baseband transmitter circuit and generate one or more intermediate signals based on the one or more baseband signals, each of the one or more intermediate signals having an intermediate frequency greater than the baseband frequency of a corresponding one of the one or more baseband signals; an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

Illustrative clause 45. A receiver, comprising: a carrier substrate having a carrier surface and comprising a plurality of first conductive pads disposed on the carrier surface; an interposer substrate having a first interposer surface and a second interposer surface opposite the first interposer surface, the second interposer surface abutting the carrier surface; a baseband receiver circuit disposed on the first interposer surface; one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz); a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals; wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals; wherein the at least two first conductive pads are operable to receive the one or more baseband signals from the baseband receiver circuit via two or more wire bond connections extending between the baseband receiver circuit and the at least two first conductive pads; and a client-side output comprising a plurality of conductive traces disposed on the carrier surface, at least two conductive traces of the plurality of conductive traces being operable to receive the one or more baseband signals from the at least two first conductive pads and transmit the one or more baseband signals.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A transmitter, comprising:
a carrier substrate having a carrier surface and comprising a plurality of first conductive pads disposed on the carrier surface;
a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency;
an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to the at least two first conductive pads;
a baseband transmitter circuit disposed on the first interposer surface and operable to receive the one or more baseband signals from the at least two first conductive pads via the at least two vias and generate one or more intermediate signals based on the one or more baseband signals, each of the one or more intermediate signals having an intermediate frequency greater than the baseband frequency of a corresponding one of the one or more baseband signals; an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and
one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

2. The transmitter of claim 1, wherein each of the plurality of first conductive pads and the plurality of second conductive pads has a diameter in a range between 5 micrometers (μm) and 100 μm.

3. The transmitter of claim 1, wherein each of the plurality of first conductive pads and the plurality of second conductive pads is one of a copper (Cu) pillar, a solder bump constructed using one or more of tin (Sn), silver (Ag), and gold (Au), and a direct bond interconnect (DBI).

4. The transmitter of claim 1, wherein each of the interposer substrate and the up-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

5. The transmitter of claim 1, wherein the baseband transmitter circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

6. The transmitter of claim 1, wherein the client data is encoded in each of the one or more baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

7. The transmitter of claim 1, further comprising one or more antennas electrically coupled to the one or more antenna interfaces and operable to receive the one or more antenna feed signals from the one or more antenna interfaces, generate one or more radiated signals based on the one or more antenna feed signals, and couple the one or more radiated signals into a hollow waveguide, each of the one or more radiated signals being radiated electromagnetic waves and having the transmission frequency.

8. The transmitter of claim 1, wherein the plurality of vias includes:
a plurality of through-silicon vias (TSVs) configured to route signals between the first interposer surface and the second interposer surface, at least two TSVs of the plurality of TSVs being aligned with and electrically coupled to the at least two second conductive pads, the baseband transmitter circuit being operable to receive the one or more baseband signals from the at least two second conductive pads via the at least two TSVs; and
one or more thermal vias configured to conduct heat away from the first interposer surface and toward the second interposer surface.

9. The transmitter of claim 8, wherein at least one thermal via of the one or more thermal vias is disposed between the up-conversion circuit and the carrier substrate and is further operable to conduct heat away from the up-conversion circuit and toward the carrier substrate.

10. A receiver, comprising:
a carrier substrate having a carrier surface and comprising a plurality of first conductive pads disposed on the carrier surface;
an interposer substrate having a first interposer surface and a second interposer surface opposite the first interposer surface and defining a plurality of vias extending between the first interposer surface and the second interposer surface, the second interposer surface abutting the carrier surface such that at least two vias of the plurality of vias are aligned with and electrically coupled to at least two first conductive pads of the plurality of first conductive pads;
a baseband receiver circuit disposed on the first interposer surface;
one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz);
a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals;
wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals;
wherein the at least two first conductive pads are operable to receive the one or more baseband signals from the baseband receiver circuit via the at least two vias; and
a client-side output comprising a plurality of conductive traces disposed on the carrier surface, at least two conductive traces of the plurality of conductive traces being operable to receive the one or more baseband signals from the at least two first conductive pads and transmit the one or more baseband signals.

11. The receiver of claim 10, wherein each of the plurality of first conductive pads and the plurality of second conductive pads has a diameter in a range between 5 micrometers (μm) and 100 μm.

12. The receiver of claim 10, wherein each of the plurality of first conductive pads and the plurality of second conductive pads is one of a copper (Cu) pillar, a solder bump constructed using one or more of tin (Sn), silver (Ag), and gold (Au), and a direct bond interconnect (DBI).

13. The receiver of claim 10, wherein each of the interposer substrate and the down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

14. The receiver of claim 10, wherein the baseband receiver circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

15. The receiver of claim 10, wherein the client data is encoded in each of the one or more baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

16. The receiver of claim 10, further comprising one or more antennas electrically coupled to the one or more antenna interfaces and operable to detect one or more radiated signals coupled into a hollow waveguide and generate the one or more antenna output signals based on the one or more radiated signals, each of the one or more radiated signals being radiated electromagnetic waves and having the transmission frequency.

17. The receiver of claim 10, wherein the plurality of vias include:
a plurality of through-silicon vias (TSVs) configured to route signals between the first interposer surface and the second interposer surface, at least two TSVs of the plurality of TSVs being aligned with and electrically coupled to the at least two first conductive pads, the at least two first conductive pads being operable to receive the one or more baseband signals from the baseband receiver circuit via the at least two TSVs; and
one or more thermal vias configured to conduct heat away from the first interposer surface and toward the second interposer surface.

18. The receiver of claim 17, wherein at least one thermal via of the one or more thermal vias is disposed between the down-conversion circuit and the carrier substrate and is further operable to conduct heat away from the down-conversion circuit and toward the carrier substrate.

19. A transceiver, comprising:
a carrier substrate having a carrier surface and comprising a plurality of first outbound conductive pads and a plurality of first inbound conductive pads disposed on the carrier surface;
a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency;
an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to at least two first inbound conductive pads of the plurality of first inbound conductive pads;
a baseband transmitter circuit disposed on the first interposer surface and operable to receive the one or more outbound baseband signals from the at least two first outbound conductive pads via the at least two first vias and generate one or more outbound intermediate signals based on the one or more outbound baseband signals, each of the one or more outbound intermediate signals having an outbound intermediate frequency greater than the outbound baseband frequency of a corresponding one of the one or more outbound baseband signals; a baseband receiver circuit disposed on the first interposer surface;
an up-conversion circuit having an up-conversion surface and comprising a plurality of second outbound conductive pads disposed on the up-conversion surface, the up-conversion surface abutting the first interposer surface such that at least two second outbound conductive pads of the plurality of second outbound conductive pads are electrically coupled to the baseband transmitter circuit, the up-conversion circuit being operable to receive the one or more outbound intermediate signals from the baseband transmitter circuit via the at least two second outbound conductive pads and generate one or more antenna feed signals based on the one or more outbound intermediate signals, each of the one or more antenna feed signals having an outbound transmission frequency greater than the outbound intermediate frequency of a corresponding one of the one or more outbound intermediate signals and in a range between 300 Gigahertz (GHz) and 10 Terahertz (THz);
one or more outbound antenna interfaces disposed on the first interposer surface, each of the one or more outbound antenna interfaces being configured to be electrically coupled to one or more outbound antennas and operable to receive the one or more antenna feed signals from the up-conversion circuit and provide the one or more antenna feed signals to the one or more outbound antennas;
one or more inbound antenna interfaces disposed on the first interposer surface, each of the one or more inbound antenna interfaces being configured to be electrically coupled to one or more inbound antennas and operable to receive one or more antenna output signals from the one or more inbound antennas, each of the one or more antenna output signals having inbound client data encoded therein and an inbound transmission frequency in a range between 300 GHz and 10 THz;
a down-conversion circuit having a down-conversion surface and comprising a plurality of second inbound conductive pads disposed on the down-conversion surface, the down-conversion surface abutting the first interposer surface such that at least two second inbound conductive pads of the plurality of second inbound conductive pads are electrically coupled to the baseband receiver circuit, the down-conversion circuit being operable to receive the one or more antenna output signals from the one or more inbound antenna interfaces and generate one or more inbound intermediate signals based on the one or more antenna output signals, each of the one or more inbound intermediate signals having an inbound intermediate frequency less than the inbound transmission frequency of a corresponding one of the one or more antenna output signals;
wherein the baseband receiver circuit is operable to receive the one or more inbound intermediate signals from the down-conversion circuit via the at least two second inbound conductive pads and generate one or more inbound baseband signals based on the one or more inbound intermediate signals, each of the one or more inbound baseband signals having an inbound baseband frequency less than the inbound intermediate frequency of a corresponding one of the one or more inbound intermediate signals;
wherein the at least two first inbound conductive pads of the plurality of first inbound conductive pads are operable to receive the one or more inbound baseband signals from the baseband receiver circuit via the at least two second vias; and
a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

20. The transceiver of claim 19, wherein each of the plurality of first outbound conductive pads, the plurality of second outbound conductive pads, the plurality of first inbound conductive pads, and the plurality of second inbound conductive pads has a diameter in a range between 5 micrometers (μm) and 100 μm.

21. The transceiver of claim 19, wherein each of the plurality of first outbound conductive pads, the plurality of second outbound conductive pads, the plurality of first inbound conductive pads, and the plurality of second inbound conductive pads is one of a copper (Cu) pillar, a solder bump constructed using one or more of tin (Sn), silver (Ag), and gold (Au), and a direct bond interconnect (DBI).

22. The transceiver of claim 19, wherein each of the interposer substrate, the up-conversion circuit, and the down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

23. The transceiver of claim 21, wherein each of the baseband transmitter circuit and the baseband receiver circuit is implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

24. The transceiver of claim 19, wherein the outbound client data is encoded in each of the one or more outbound baseband signals and the inbound client data is encoded in each of the one or more inbound baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

25. The transceiver of claim 19, further comprising:
one or more outbound antennas electrically coupled to the one or more outbound antenna interfaces and operable to receive the one or more antenna feed signals from the one or more outbound antenna interfaces, generate one or more outbound radiated signals based on the one or more antenna feed signals, and couple the one or more outbound radiated signals into a first hollow waveguide, each of the one or more outbound radiated signals being radiated electromagnetic waves and having the outbound transmission frequency; and
one or more inbound antennas electrically coupled to the one or more inbound antenna interfaces and operable to detect one or more inbound radiated signals coupled into one of the first hollow waveguide and a second hollow waveguide and generate the one or more antenna output signals based on the one or more inbound radiated signals, each of the one or more inbound radiated signals being radiated electromagnetic waves and having the inbound transmission frequency.

26. The transceiver of claim 19, wherein the plurality of vias includes:
a plurality of through-silicon vias (TSVs) configured to route signals between the first interposer surface and the second interposer surface, at least two first TSVs of the plurality of TSVs being aligned with and electrically coupled to the at least two first outbound conductive pads, at least two second TSVs of the plurality of TSVs being aligned with and electrically coupled to the at least two first inbound conductive pads, the baseband transmitter circuit being operable to receive the one or more outbound baseband signals from the plurality of first outbound conductive pads via the at least two first TSVs, the at least two first inbound conductive pads being operable to receive the one or more inbound baseband signals from the baseband receiver circuit via the at least two second TSVs; and one or more thermal vias configured to conduct heat away from the first interposer surface and toward the second interposer surface.

27. The transceiver of claim 26, wherein the one or more thermal vias are further defined as a plurality of thermal vias, at least one first thermal via of the plurality of thermal vias being disposed between the up-conversion circuit and the carrier substrate and being further operable to conduct heat away from the up-conversion circuit and toward the carrier substrate and at least one second thermal via of the plurality of thermal vias being disposed between the down-conversion circuit and the carrier substrate and being further operable to conduct heat away from the down-conversion circuit and toward the carrier substrate.

28. The transceiver of claim 19, wherein the baseband transmitter circuit and the baseband receiver circuit are integrated into a single semiconductor die.

29. The transceiver of claim 19, wherein the up-conversion circuit and the down-conversion circuit are integrated into a single semiconductor die.

30. The transceiver of claim 19, wherein the baseband transmitter circuit and the baseband receiver circuit are integrated into a first semiconductor die and the up-conversion circuit and the down-conversion circuit are integrated into a second semiconductor die.

31. A transceiver, comprising:
a carrier substrate having a carrier surface and comprising a plurality of first outbound conductive pads and a plurality of first inbound conductive pads disposed on the carrier surface;
a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency;
an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of are aligned with and electrically coupled to at least two first inbound conductive pads of the plurality of first inbound conductive pads;
a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals;
a baseband receiver circuit disposed on the first interposer surface;
a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz);
one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas;
a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz;
one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas;
one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz;
a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals;
one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz;
a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals;
wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals;
wherein the at least two first inbound conductive pads are operable to receive the one or more inbound baseband signals from the baseband receiver circuit via the at least two second vias; and
a client-side output comprising a plurality of second conductive traces disposed on the carrier surface, at least two second conductive traces of the plurality of second conductive traces being operable to receive the one or more inbound baseband signals from the at least two first inbound conductive pads and transmit the one or more inbound baseband signals.

32. The transceiver of claim 31, wherein each of the plurality of first outbound conductive pads, the plurality of second outbound conductive pads, the plurality of third outbound conductive pads, the plurality of first inbound conductive pads, the plurality of second inbound conductive pads, and the plurality of third inbound conductive pads has a diameter in a range between 5 micrometers (μm) and 100 μm.

33. The transceiver of claim 31, wherein each of the plurality of first outbound conductive pads, the plurality of second outbound conductive pads, the plurality of third outbound conductive pads, the plurality of first inbound conductive pads, the plurality of second inbound conductive pads, and the plurality of third inbound conductive pads is one of a copper (Cu) pillar, a solder bump constructed using one or more of tin (Sn), silver (Ag), and gold (Au), and a direct bond interconnect (DBI).

34. The transceiver of claim 31, wherein each of the interposer substrate, the first up-conversion circuit, the second up-conversion circuit, the first down-conversion circuit, and the second down-conversion circuit is implemented using one or more of complementary metal-oxide semiconductor (CMOS) technology, bipolar CMOS (BiCMOS) technology, silicon (Si) semiconductor technology, bipolar Si semiconductor technology, silicon germanium (SiGe) semiconductor technology, bipolar SiGe semiconductor technology, indium phosphide (InP) semiconductor technology, and bipolar InP semiconductor technology.

35. The transceiver of claim 31, wherein each of the baseband transmitter circuit and the baseband receiver circuit are implemented using one or more of silicon (Si) semiconductor technology, gallium arsenide (GaAs) semiconductor technology, gallium nitride (GaN) semiconductor technology, indium phosphide (InP) semiconductor technology, and complementary metal-oxide semiconductor (CMOS) technology.

36. The transceiver of claim 31, wherein the outbound client data is encoded in each of the one or more outbound baseband signals and the first inbound client data and the second inbound client data are encoded in each of the one or more inbound baseband signals using an encoding protocol conforming to requirements of one of non-return-to-zero (NRZ) code, phase-amplitude modulation with two levels (PAM2), phase-amplitude modulation with three levels (PAM3), and phase-amplitude modulation with four levels (PAM4).

37. The transceiver of claim 31, further comprising:
one or more first outbound antennas electrically coupled to the one or more first outbound antenna interfaces and operable to receive the one or more first antenna feed signals from the one or more first outbound antenna interfaces, generate one or more first outbound radiated signals based on the one or more first antenna feed signals, and couple the one or more first outbound radiated signals into a first hollow waveguide, each of the one or more first outbound radiated signals being radiated electromagnetic waves and having the first outbound transmission frequency;
one or more second outbound antennas electrically coupled to the one or more second outbound antenna interfaces and operable to receive the one or more second antenna feed signals from the one or more second outbound antenna interfaces, generate one or more second outbound radiated signals based on the one or more second antenna feed signals, and couple the one or more second outbound radiated signals into one of the first hollow waveguide and a second hollow waveguide;
one or more first inbound antennas electrically coupled to the one or more first inbound antenna interfaces and operable to detect one or more first inbound radiated signals coupled into one of the first hollow waveguide, the second hollow waveguide, and a third hollow waveguide and generate the one or more first antenna output signals based on the one or more first inbound radiated signals, each of the one or more first inbound radiated signals being radiated electromagnetic waves and having the first inbound transmission frequency; and one or more second inbound antennas electrically coupled to the one or more second inbound antenna interfaces and operable to detect one or more second inbound radiated signals coupled into one of the first hollow waveguide, the second hollow waveguide, the third hollow waveguide, and a fourth hollow waveguide and generate the one or more second antenna output signals based on the one or more second inbound radiated signals, each of the one or more second inbound radiated signals being radiated electromagnetic waves and having the second inbound transmission frequency.

38. The transceiver of claim 31, wherein the plurality of vias includes:
a plurality of through-silicon vias (TSVs) configured to route signals between the first interposer surface and the second interposer surface, at least two first TSVs of the plurality of TSVs being aligned and electrically coupled to with the at least two first outbound conductive pads, at least two second TSVs of the plurality of TSVs being aligned with and electrically coupled to the at least two first inbound conductive pads, the baseband transmitter circuit being operable to receive the one or more outbound baseband signals from the plurality of first outbound conductive pads via the at least two first TSVs, the at least two first inbound conductive pads being operable to receive the one or more inbound baseband signals from the baseband receiver circuit via the at least two second TSVs; and one or more thermal vias configured to conduct heat away from the first interposer surface and toward the second interposer surface.

39. The transceiver of claim 38, wherein the one or more thermal vias are further defined as a plurality of thermal vias, at least one first thermal via of the plurality of thermal vias being disposed between the first up-conversion circuit and the carrier substrate and being further operable to conduct heat away from the first up-conversion circuit and toward the carrier substrate, at least one second thermal via of the plurality of thermal vias being disposed between the second up-conversion circuit and the carrier substrate and being further operable to conduct heat away from the second up-conversion circuit and toward the carrier substrate, at least one third thermal via of the plurality of thermal vias being disposed between the first down-conversion circuit and the carrier substrate and being further operable to conduct heat away from the first down-conversion circuit and toward the carrier substrate, at least one fourth thermal via of the plurality of thermal vias being disposed between the second down-conversion circuit and the carrier substrate and being further operable to conduct heat away from the second down-conversion circuit and toward the carrier substrate.

40. The transceiver of claim 31, wherein the baseband transmitter circuit and the baseband receiver circuit are integrated into a single semiconductor die.

41. The transceiver of claim 31, wherein the first up-conversion circuit and the first down-conversion circuit are integrated into a first semiconductor die and the second up-conversion circuit and the second down-conversion circuit are integrated into a second semiconductor die.

42. The transceiver of claim 31, wherein the baseband transmitter circuit and the baseband receiver circuit are integrated into a first semiconductor die, the first up-conversion circuit and the first down-conversion circuit are integrated into a second semiconductor die, and the second up-conversion circuit and the second down-conversion circuit are integrated into a third semiconductor die.

43. A transceiver array, comprising:
a carrier substrate having a carrier surface and comprising a plurality of first outbound conductive pads and a plurality of first inbound conductive pads disposed on the carrier surface;
a client-side input comprising a plurality of first conductive traces disposed on the carrier surface, at least two first conductive traces of the plurality of first conductive traces being operable to receive one or more outbound baseband signals, at least two first outbound conductive pads of the plurality of first outbound conductive pads being operable to receive the one or more outbound baseband signals from the at least two first conductive traces, each of the one or more outbound baseband signals having outbound client data encoded therein and having an outbound baseband frequency;
a client-side output comprising a plurality of second conductive traces disposed on the carrier surface, at least two second conductive traces of the plurality of second conductive traces being operable to receive one or more inbound baseband signals from at least two first inbound conductive pads of the plurality of first inbound conductive pads and transmit the one or more inbound baseband signals; and
a plurality of transceivers, each of the plurality of transceivers comprising:
an interposer substrate having a first interposer surface and a second interposer surface opposite the first interposer surface and defining a plurality of vias extending between the first interposer surface and the second interposer surface, the second interposer surface abutting the carrier surface such that at least two first vias of the plurality of vias are aligned with and electrically coupled to the at least two first outbound conductive pads and at least two second vias of the plurality of vias are aligned with and electrically coupled to the at least two first inbound conductive pads;
a baseband transmitter circuit disposed on the first interposer surface and operable to receive the one or more outbound baseband signals from the at least two first outbound conductive pads via the at least two first vias and generate one or more first outbound intermediate signals and one or more second outbound intermediate signals based on the one or more outbound baseband signals, each of the one or more first outbound intermediate signals having a first outbound intermediate frequency greater than the outbound baseband frequency of a corresponding one of the one or more outbound baseband signals, each of the one or more second outbound intermediate signals having a second outbound intermediate frequency greater than the outbound baseband frequency of a corresponding one of the one or more outbound baseband signals;
a baseband receiver circuit disposed on the first interposer surface;
a first up-conversion circuit having a first up-conversion surface and comprising a plurality of second outbound conductive pads disposed on the first up-conversion surface, the first up-conversion surface abutting the first interposer surface such that at least two second outbound conductive pads of the plurality of second outbound conductive pads are electrically coupled to the baseband transmitter circuit, the first up-conversion circuit being operable to receive at least one first outbound intermediate signal of the one or more first outbound intermediate signals from the baseband transmitter circuit via the at least two second outbound conductive pads and generate one or more first antenna feed signals based on the at least one first outbound intermediate signal, each of the one or more first antenna feed signals having a first outbound transmission frequency greater than the first outbound intermediate frequency of a corresponding one of the at least one first outbound intermediate signal and in a range between 300 Gigahertz (GHz) and 10 Terahertz (THz);
one or more first outbound antenna interfaces disposed on the first interposer surface, each of the one or more first outbound antenna interfaces being configured to be electrically coupled to one or more first outbound antennas and operable to receive the one or more first antenna feed signals from the first up-conversion circuit and provide the one or more first antenna feed signals to the one or more first outbound antennas;
a second up-conversion circuit having a second up-conversion surface and comprising a plurality of third outbound conductive pads disposed on the second up-conversion surface, the second up-conversion surface abutting the first interposer surface such that at least two third outbound conductive pads of the plurality of third outbound conductive pads are electrically coupled to the baseband transmitter circuit, the second up-conversion circuit being operable to receive at least one second outbound intermediate signal of the one or more second outbound intermediate signals from the baseband transmitter circuit via the at least two third outbound conductive pads and generate one or more second antenna feed signals based on the at least one second outbound intermediate signal, each of the one or more second antenna feed signals having a second outbound transmission frequency greater than the second outbound intermediate frequency of a corresponding one of the at least one second outbound intermediate signal and in a range between 300 GHz and 10 THz;
one or more second outbound antenna interfaces disposed on the first interposer surface, each of the one or more second outbound antenna interfaces being configured to be electrically coupled to one or more second outbound antennas and operable to receive the one or more second antenna feed signals from the second up-conversion circuit and provide the one or more second antenna feed signals to the one or more second outbound antennas;
one or more first inbound antenna interfaces disposed on the first interposer surface, each of the one or more first inbound antenna interfaces being configured to be electrically coupled to one or more first inbound antennas and operable to receive one or more first antenna output signals from the one or more first inbound antennas, each of the one or more first antenna output signals having first inbound client data encoded therein and a first inbound transmission frequency in a range between 300 GHz and 10 THz;
a first down-conversion circuit having a first down-conversion surface and comprising a plurality of second inbound conductive pads disposed on the first down-conversion surface, the first down-conversion surface abutting the first interposer surface such that at least two second inbound conductive pads of the plurality of second inbound conductive pads are electrically coupled to the baseband receiver circuit, the first down-conversion circuit being operable to receive the one or more first antenna output signals from the one or more first inbound antenna interfaces and generate one or more first inbound intermediate signals based on the one or more first antenna output signals, each of the one or more first inbound intermediate signals having a first inbound intermediate frequency less than the first inbound transmission frequency of a corresponding one of the one or more first antenna output signals;
one or more second inbound antenna interfaces disposed on the first interposer surface, each of the one or more second inbound antenna interfaces being configured to be electrically coupled to one or more second inbound antennas and operable to receive one or more second antenna output signals from the one or more second inbound antennas, each of the one or more second antenna output signals having second inbound client data encoded therein and a second inbound transmission frequency in a range between 300 GHz and 10 THz;
a second down-conversion circuit having a second down-conversion surface and comprising a plurality of third inbound conductive pads disposed on the second down-conversion surface, the second down-conversion surface abutting the first interposer surface such that at least two third inbound conductive pads of the plurality of third inbound conductive pads are electrically coupled to the baseband receiver circuit, the second down-conversion circuit being operable to receive the one or more second antenna output signals from the one or more second inbound antenna interfaces and generate one or more second inbound intermediate signals based on the one or more second antenna output signals, each of the one or more second inbound intermediate signals having a second inbound intermediate frequency less than the second inbound transmission frequency of a corresponding one of the one or more second antenna output signals;
wherein the baseband receiver circuit is operable to receive the one or more first inbound intermediate signals from the first down-conversion circuit via the at least two second inbound conductive pads and the one or more second inbound intermediate signals from the second down-conversion circuit via the at least two third inbound conductive pads and generate the one or more inbound baseband signals based on the one or more first inbound intermediate signals and the one or more first inbound intermediate signals, at least one first inbound baseband signal of the one or more inbound baseband signals having a first inbound baseband frequency less than the first inbound intermediate frequency of a corresponding one of the one or more first inbound intermediate signals and at least one second inbound baseband signal of the one or more inbound baseband signals having a second inbound baseband frequency less than the second inbound intermediate frequency of a corresponding one of the one or more second inbound intermediate signals; and
wherein the at least two first inbound conductive pads are operable to receive the one or more inbound baseband signals from the baseband receiver circuit via the at least two second vias.

44. A transmitter, comprising:
a carrier substrate having a carrier surface and comprising a plurality of first conductive pads disposed on the carrier surface;
a client-side input comprising a plurality of conductive traces disposed on the carrier surface, at least two conductive traces of the plurality of conductive traces being operable to receive one or more baseband signals, at least two first conductive pads of the plurality of first conductive pads being operable to receive the one or more baseband signals from the at least two conductive traces, each of the one or more baseband signals having client data encoded therein and having a baseband frequency;
an interposer substrate having a first interposer surface and a second interposer surface opposite the first interposer surface, the second interposer surface abutting the carrier surface;
a baseband transmitter circuit disposed on the first interposer surface and operable to receive the one or more baseband signals from the at least two first conductive pads via two or more wire bond connections extending between the at least two first conductive pads and the baseband transmitter circuit and generate one or more intermediate signals based on the one or more baseband signals, each of the one or more intermediate signals having an intermediate frequency greater than the baseband frequency of a corresponding one of the one or more baseband signals;
an up-conversion circuit having an up-conversion surface and comprising a plurality of second conductive pads disposed on the up-conversion surface, the up-conversion surface abutting the first interposer surface such that at least two second conductive pads of the plurality of second conductive pads are electrically coupled to the baseband transmitter circuit, the up-conversion circuit being operable to receive the one or more intermediate signals from the baseband transmitter circuit via the at least two second conductive pads and generate one or more antenna feed signals based on the one or more intermediate signals, each of the one or more antenna feed signals having a transmission frequency greater than the intermediate frequency of a corresponding one of the one or more intermediate signals and in a range between 300 Gigahertz (GHz) and 10 Terahertz (THz); and
one or more antenna interfaces disposed on the first interposer surface, each of the one or more antenna interfaces being configured to be electrically coupled to one or more antennas and operable to receive the one or more antenna feed signals from the up-conversion circuit and provide the one or more antenna feed signals to the one or more antennas.

45. A receiver, comprising:
a carrier substrate having a carrier surface and comprising a plurality of first conductive pads disposed on the carrier surface;
an interposer substrate having a first interposer surface and a second interposer surface opposite the first interposer surface, the second interposer surface abutting the carrier surface;
a baseband receiver circuit disposed on the first interposer surface;
one or more antenna interfaces disposed on the first interposer surface, each of the one or more antenna interfaces being configured to be electrically coupled to one or more antennas and operable to receive one or more antenna output signals from the one or more antennas, each of the one or more antenna output signals having client data encoded therein and a transmission frequency in a range between 300 Gigahertz (GHz) and 10 Terahertz (THz);
a down-conversion circuit having a down-conversion surface and comprising a plurality of second conductive pads disposed on the down-conversion surface, the down-conversion surface abutting the first interposer surface such that at least two second conductive pads of the plurality of second conductive pads are electrically coupled to the baseband receiver circuit, the down-conversion circuit being operable to receive the one or more antenna output signals from the one or more antenna interfaces and generate one or more intermediate signals based on the one or more antenna output signals, each of the one or more intermediate signals having an intermediate frequency less than the transmission frequency of a corresponding one of the one or more antenna output signals;
wherein the baseband receiver circuit is operable to receive the one or more intermediate signals from the down-conversion circuit via the at least two second conductive pads and generate one or more baseband signals based on the one or more intermediate signals, each of the one or more baseband signals having a baseband frequency less than the intermediate frequency of a corresponding one of the one or more intermediate signals;
wherein the at least two first conductive pads are operable to receive the one or more baseband signals from the baseband receiver circuit via two or more wire bond connections extending between the baseband receiver circuit and the at least two first conductive pads; and
a client-side output comprising a plurality of conductive traces disposed on the carrier surface, at least two conductive traces of the plurality of conductive traces being operable to receive the one or more baseband signals from the at least two first conductive pads and transmit the one or more baseband signals.
